(19) United States
(12) Patent Application Publication
(10) Pub. No.: US 2009/0086657 A1
(43) Pub. Date: Apr. 2, 2009

(54) HYBRID AUTOMATIC REPEAT REQUEST BUFFER FLUSHING MECHANISM

(75) Inventors: Yaron Alpert, Hod Hasharon (IL); Jonathan Segev, Tel Moad (IL)

Correspondence Address: Zaretsky Patent Group PC, 20783 N 83rd Ave, Ste 103-174, Peoria, AZ, 85382-7430, US

(73) Assignee: Comsys Communication & Signal Processing Ltd.

(21) Appl. No.: 12/045,103

(22) Filed: Mar. 10, 2008

Related U.S. Application Data
(60) Provisional application No. 60/976,613, filed on Oct. 1, 2007.

(51) Int. Cl. H04B 7/00

(52) U.S. Cl. 370/310

(57) ABSTRACT

A novel and useful buffer flushing mechanism for use in a communications link. Using hybrid automatic repeat request (HARQ) protocol mechanisms, network elements in a radio access network initiate a HARQ buffer flushing operation. Network elements on both ends of a communication link can autonomously initiate coordinated or uncoordinated flushing of their respective HARQ process buffers based on internal algorithms and/or criteria previously negotiated between the two elements. The flushing operation may be performed on all or a part of the buffer (transmit and/or receive) or on certain complete or partial accumulated information. The criteria may comprise any suitable data including, for example, timeout data, thresholds based on one or more link quality parameters, data measurements exceeding a threshold, etc. which can be used to trigger a buffer flushing event.

### REFERENCE TO PRIORITY APPLICATION

This application claims priority to U.S. Provisional Application Ser. No. 60/976,613, filed Oct. 1, 2007, entitled “Method and Apparatus for Hybrid Repeat Request (HARQ) Buffer Management,” incorporated herein by reference in its entirety.

### FIELD OF THE INVENTION

The present invention relates generally to wireless communication systems and more particularly relates to a HARQ buffer flushing operation mechanism for use in a communication system.

### BACKGROUND OF THE INVENTION

### Automatic Repeat-reQuest (ARQ) and HARQ Protocols

Automatic repeat-request or ARQ is a well-known error control technique for data transmission which utilizes acknowledgments and timeouts to achieve reliable data transmission. ARQ acknowledgments are messages sent by the receiver to the transmitter to indicate that the receiver correctly received an information unit. Timeouts are reasonable points in time after the sender transmits the information unit. The sender usually re-transmits the information unit if it does not receive an acknowledgment before the timeout. It continues to re-transmit the information unit until it either receives an acknowledgment from the receiver or exceeds a predefined number of re-transmission attempts.

Several types of ARQ protocols include stop-and-wait ARQ, go-back-N ARQ and selective repeat ARQ. These protocols typically reside in the Data Link or Transport Layer of the OSI model.

In stop-and-wait ARQ, the sender transmits one information unit (i.e. packet, data frame, transmission burst, burst, PDU, etc,) at a time. After sending each information unit the sender does not send any more information units until it receives an acknowledgement or ACK signal or message from the receiver. At the receiver, an ACK is sent back to the sender if the information unit was received correctly. If the ACK does not reach the sender before the timeout expires, the sender transmits the information unit again.

One problem with stop-and-wait ARQ occurs when the ACK sent by the receiver is damaged or lost. In this case, the sender does not receive the ACK, times out, and sends the information unit again. The receiver, however, now may has two copies of the same information unit, and does not know if the second one is a duplicate frame or the next information unit of the sequence carrying identical data.

Another problem occurs when the transmission medium has such a long latency period that the sender's timeout runs out before the information unit reaches the receiver, thus causing significant deterioration in throughput. In this case, the sender resends the same information unit. Eventually the receiver gets two copies of the same information unit, and sends an ACK for each one. The sender, waiting for a single ACK, receives two ACKs, which will cause problems if it assumes that the second ACK is for the next information unit in the sequence. The stop-and-wait ARQ protocol, however, is inefficient compared to other ARQ protocols because the time between information units is twice the transit time significantly lowering channel utilization.

In the go-back-N ARQ protocol, the sending process continues to send a number of mapped or marks information units specified by a window size even without receiving an ACK from the receiver. The receiver process keeps track of the sequence number of the next information unit it expects to receive, and sends that number with every ACK it sends. The receiver will ignore any information unit that does not have the exact sequence number it expects. Once the sender has sent all or known number of the information units in its window, it detects that all of the information units since the first lost information units are outstanding, and will go back to sequence number of the last ACK it received from the receiver process and fill its window starting with that information unit and continue the process over again.

The go-back-N ARQ protocol make more efficient use of a connection since unlike waiting for an acknowledgement for each information unit, the connection is still utilized as pack information units are being sent. This method, however, causes information units to be sent multiple times. If any information unit was lost or damaged, or the ACK acknowledging them was lost or damaged, then that information unit and all following information units in the window will be re-sent therefore this mechanism does not suit lossy environments such as wireless channels.

In the selective repeat ARQ protocol, the sending process continues to send a number of information units specified by a window size even after an information unit loss. Unlike the go-back-N ARQ protocol, the receiving process continues to accept and acknowledge information units sent after an initial error. The receiver keeps track of the sequence number of the earliest information unit it has not received, and sends that number with every ACK it sends. If an information unit from the sender does not reach the receiver, the sender continues to send subsequent information units until its window is empty. The receiver continues to fill its receiving window with the subsequent information units, replying each time with an ACK containing the sequence number of the earliest missing information unit. Once the sender has sent all the frames in its window, it re-sends the information unit number given by the ACKs, and then continues where it left off.

Hybrid ARQ (HARQ) is a commonly used extension of the ARQ error control method which exhibits better performance, particularly over wireless channels, but at the cost of increased implementation complexity. Presently, HARQ is one of the most important technologies used for increasing data transmission reliability and data throughput in mobile communication systems. Specifically, HARQ refers to a combination of ARQ and PHY level reception techniques like Forward Error Correction (FEC) and signal combining techniques.

There are two well-known HARQ techniques: the first known as Incremental Redundancy (IR) and the second known as chase combining, discussed in more detail infra.

### HARQ Operation

The IEEE 802.16e standard provides the option of combining gain by incremental redundancy, as shown in FIG. 1 wherein subsequent transmissions incorporate additional information. HARQ is an important technique for link adaptation and makes aggressive modulation and coding schemes (MCS)-level decisions possible. Thus the use of HARQ can result in considerable increased throughput.

In HARQ, the transmitter and the receiver cooperate on an information unit (HARQ sub burst, burst, packet or block) level. The receiver is capable of indicating successful (via ACKs) or unsuccessful (via NACKs) reception of the last transmitted information unit or block. The transmitter comprises several parallel HARQ sub processors (e.g., in 802.16e referred to as HARQ sub-channels), each of which performs operations of transmitting a user information units, receiving ACK/NACK information or other ACK indications in response thereto and performing either a retransmission when needed or transmitting the next information units. The ACK indication may be direct whereby a specific ACK or NACK indication is sent. In HARQ, the receiver takes advantage of any previous retransmissions by decoding the information unit or block based on information gathered from all the retransmissions of the same information unit or block, thus improving overall performance of the communications link.

In IEEE 802.16e, HARQ schemes are optional parts of the MAC layer and can be enabled on a per-terminal per connection basis. The per-terminal HARQ and associated parameters are specified and negotiated during the initialization procedure.

Once negotiated, HARQ data is transmitted in so called sub-bursts or simply bursts. As shown in FIG. 2, HARQ sub-bursts (information units) 350 are generated by concatenating multiple MAC PDUs 354 and attaching a CRC 356 to generate HARQ ACID 358. When HARQ is enabled, the frame structure includes a HARQ zone, with up to 16 sub-bursts vertically packed inside one zone. Each sub-burst is referenced by an identifier (e.g., information element (IE)) called a HARQ_CONTROL_IE in the compact DL-UL MAP or a HARQ DL MAP IE in the regular DL.

Only Chase combining is used in the current WiMAX Rev 1.0 profile though IEEE 802.16e also supports IR. As described herein below, HARQ Chase combining requires all retransmissions to send the exact same information and to use the original modulation coding scheme (i.e. waveform). Note that HARQ retransmissions are asynchronous, in the sense that all HARQ bursts undergo opportunistic scheduling. The maximum number of retransmissions is determined by target residual packet error rate (PER). Typically the number of HARQ retransmissions is set to four for a PER of 1E-4 (this is the case for IR as well).

A benefit of employing HARQ is that it can be used to mitigate the effects of channel and interference fluctuation. HARQ provides an improvement in performance due to the SNR improvement derived from the energy and time diversity gain achieved by (1) combining retransmitted packets with previous erroneously decoded packets and/or (2) using Incremental Redundancy (IR) to realize additional coding gain.

A high level HARQ block diagram is shown in FIG. 3. The HARQ, generally referenced 360, comprises de-interleaver 362 whose input comprises soft valued data samples, de-puncturer 364, FEC decoder 366, CRC decoder 368 and RX buffer 369. The output of the CRC decoder is an ACK/NACK signal and the recovered data.

Using WiMAX as an example, a resource region for HARQ ACK channels is allocated using the HARQ ACK region allocation IE. This resource region may include one or more ACK channels for HARQ support enabled MSs. The UL ACK channel occupies half a slot in the HARQ ACK channel region, which may override the fast feedback region. This UL ACK channel is assigned implicitly to each HARQ-enabled burst, according to the order of the HARQ-enabled DL bursts in the DL-MAP. Thus, using this UL ACK channel, MSs can quickly transmit ACK or NACK feedback for DL HARQ-enabled packet data.

HARQ may also divide into several types. In the simplest version of HARQ types, called Type I HARQ, both Error Detection (ED) and Forward Error Correction (FEC) information to each message prior to transmission. When the coded data block is received, the receiver first decodes the error-correction code. If the channel quality is sufficient, all transmission errors should be correctable, and the receiver can obtain the correct data block. If the channel quality is bad and not all transmission errors can be corrected, the receiver detects this situation using the error-detection code, the received coded data block is discarded and a retransmission is requested by the receiver.

In the more sophisticated Type II HARQ, only (1) ED bits or (2) FEC information and ED bits are sent on a given transmission, typically alternating on successive transmissions. It is important to note that detection typically adds only a few bytes to a message, resulting in a relatively small incremental increase in message length. FEC, however, adds error correction parities which often double or triple the message length. In terms of throughput, standard ARQ typically expends a few percent of channel capacity for reliable protection against error, while FEC ordinarily expends half or more of all channel capacity for channel improvement.

In Type II HARQ, the first transmission contains only data and error detection. If it is received in error, the second transmission includes FEC parities and error detection information. If the second transmission is received in error, error correction is attempted by combining the information received from both transmissions. Incorrectly received coded data blocks are often stored in buffer memory at the receiver rather than discarded. When the retransmitted block is received, the two blocks are combined, using a technique known as chase combining, which increases the likelihood of correctly decoding the message.

### HARQ Incremental Redundancy and Chase Combining

HARQ Incremental redundancy (IR) enables higher data rates by combining information from different transmissions of radio link control (RLC) data blocks the decoding process. IR is also known as hybrid type II/III ARQ.

When in EGPRS Temporary Block Flow (TBF) mode, the transfer of RLC data blocks in the acknowledged RLC/MAC mode may be controlled by a selective Type I ARQ mechanism, or by Type II hybrid ARQ (IR) mechanism, coupled with the numbering of the RLC data blocks within one temporary block flow.

The receiver can thus operate either in Type I or Type II hybrid ARQ mode. In the Type I ARQ mode, decoding of an RLC data block is based solely on the prevailing transmission (i.e. erroneous blocks are not stored). In the Type II ARQ case, erroneous blocks are stored by the receiver and a joint decoding with new transmissions is performed.

Chase combining HARQ is supported to further improve the reliability of a retransmission stored in a HARQ buffer by combining one or more previous transmissions decoded in error. In HARQ Chase combining all retransmissions sent include the same information and use the original modulation coding scheme. To streamline the HARQ feedback, a dedicated ACK channel is also provided on the transmission side for purposes of HARQ ACK/NACK signaling.

HARQ can be used to mitigate the effect of channel and interference fluctuations. HARQ provides a performance improvement due to (1) the SNR gain and time diversity achieved by combining one or more previous erroneously decoded information units and retransmitted information units and (2) the additional coding gain achieved from incremental redundancy (IR).

Stop-and-wait automatic repeat request (ARQ) with a single or small number of channels is inefficient. Therefore HARQ is enabled using several (N) parallel “stop-and-wait” processes (also referred to as HARQ channels) which provides fast response to packet errors, improves cell edge coverage and maintains a suitable quality of service (QoS) level in terms of throughput, delay, jitter, etc. Mobile WiMAX provides signaling to allow fully asynchronous HARQ operation. Moreover, HARQ combined with the Channel Quality Indicator (CQI) channel and adaptive modulation and coding offers a powerful mechanism for robust link adaptation in mobile environments at vehicular speeds up to 250 km/hr.

### Example WiMAX/OFDMA Network

As an example, consider the example prior art multiple access wireless communications system shown in FIG. 4. The system, generally referenced 10, comprises a base station 12 in wireless communication with a plurality of user equipment (UE), 16 labeled user equipment 1 through N (also referred to as mobile stations (MS) or subscriber units (SU)). The base station transmits frames 14 to the UEs which comprise control information and data.

Orthogonal Frequency Division Multiplexing (OFDM), a digital multi-carrier modulation scheme, is well known in the art. It uses a large number of closely spaced subcarriers that are orthogonal to each other. Each subcarrier is modulated with a conventional modulation scheme (e.g., quadrature amplitude modulation (QAM)) at a low symbol rate, maintaining data rates similar to conventional single carrier modulation schemes in the same bandwidth. The OFDM signals are typically generated using inverse fast Fourier transforms (IFFT) and fast Fourier transforms (FFT).

The primary advantage of OFDM over single-carrier schemes is its ability to cope with severe channel conditions, such as high frequency attenuation in copper wire, narrowband interference and frequency selective fading due to multipath, without the need for complex equalization filters in the receiver. Channel equalization is simplified because OFDM may be viewed as using many slowly modulated narrowband signals rather than one rapidly modulated wideband signal. The low symbol rate makes the use of a guard interval between symbols practicable, thereby making it possible to handle time spreading and eliminate intersymbol interference (ISI).

Orthogonal Frequency Division Multiple Access (OFDMA) is a multi-user version of the OFDM digital modulation scheme. Multiple access is achieved in OFDMA by assigning subsets of subcarriers to individual users. This permits simultaneous low data rate transmission from/to several users. Adaptive user to subcarrier assignment is achieved based on feedback information about channel conditions. If the assignment is performed quickly enough, the robustness of OFDM to fast fading and narrowband co-channel interference is improved, thereby making it possible to achieve even better system spectral efficiency. In practice, a different number of subcarriers can be assigned to different users, to support differentiated Quality of Service (QoS), i.e. to control the data rate and error probability individually for each user.

Currently, wireless mobile communication systems are evolving towards their forth generation (i.e. 4G networks). The evolution to 4G promises an increased number of users as well as an increase in user bandwidths. Along with an increase in mobility, these new systems will demand a substantial increase in system requirements.

Several new technologies are planning to be used to meet the increase in system requirements. One of these technologies is Orthogonal Division Multiple Access (OFDMA), a wireless technique proposed for WiMAX (IEEE 802.16e), WiFi (IEEE 802.11n), 3GPP-LTE and Ultra Mobile Broadband (UMB). Another technology for increasing system capacity (i.e. throughput, coverage, user rate, etc.) is known as ‘multiple-input multiple-output’ (MIMO) in which multiple transmit and receive antennas are used.

An OFDMA system is considered as an efficient modulation scheme which provides multiple access to a relatively large number of users with a relative simplicity by applying Fourier transform characteristics. In addition, at the receiver side, the OFDMA technology provides a relatively simple solution to the channel equalization problem. In operation, OFDMA implementation uses a fast-Fourier transform (FFT) algorithm which jointly modulates a large number of symbols over a large set of narrow band signals that are orthogonal to each other. The results of the FFT (in some cases inverse FFT or IFFT) form the basic transmission and reception element which is referred to as a symbol.

A block diagram illustrating a conventional OFDMA transceiver is shown in FIG. 5. The example OFDMA transceiver, generally referenced 20, comprises a transmit path that includes a serial to parallel conversion 22, IFFT block 24, parallel to serial conversion 26, cyclic prefix insertion 28, shaping circuit 30, digital to analog converter (DAC) 32, upconversion mixer 34, transmitter/receiver (T/R) switch 36 and antenna 38. The receive path comprises downconversion mixer 42, analog to digital converter (ADC) 44, timing clock 46, cyclic prefix removal 48, serial to parallel conversion 50, FFT block 52 and demodulator 54. The transceiver also comprises frequency reference (f_{c}) 40 and controller 56.

### Example HARQ Process in a WiMAX/OFDMA System

In the HARQ scheme, that implemented based on known as stop and wait mechanism, several parallel HARQ processes or processors are active simultaneously. Each such process consists of a transmitter side and a receiver side as shown in FIG. 6. The example communications system, generally referenced 60, comprises a base station (BS) or radio access network (RAN) 62 comprising a HARQ buffer 64 (transmit and/or receive) on one end of a communication link and a subscriber unit (SU) 66 comprising a HARQ buffer (transmit and/or receive) 68. Data 61 and HARQ ACK/NACK signaling 63 are transmitted over the communications link connecting the two devices.

The transmitter in each device typically comprises several parallel HARQ sub processors, each of which performs operations of transmitting a user information unit, receiving feedbacks likes ACK/NACK information or other ACK indications in response thereto and performing either a retransmission when needed or transmitting the next information unit. Normally, a HARQ processor can not transmit additional information units until it receives specific or implicit ACK/NACK indication in response to a recently transmitted information unit. The ACK indication may be direct, i.e. to send a specific ACK or NACK indication or may be indirect (implicit), i.e. to send a request to either transmit the next information unit or retransmit the last information unit.

A block diagram illustrating a prior art example HARQ transmit and receive system is shown in FIG. 7. The system, generally referenced 370, comprises on one side of the air interface 380, an N HARQ-channel (i.e. N parallel HARQ processes) sequencer 372, a plurality of N HARQ-TX buffers 374, FEC and modulation block 376, demodulator 378 and ACK/NACK receiver 394. On the other end of the air interface, is a demodulation block 382, a plurality of N HARQ-RX buffers 384, a plurality of N HARQ processor blocks 386 corresponding to the N HARQ-RF buffers, sequence in-liner 388, FEC decoder 392, ACK/NACK transmitter 390 and modulation block 396.

As described supra, the HARQ scheme is based on a stop-and-wait protocol. In DL HARQ, the ACK is sent by the MS after a known delay using means of fast feedback UL channels via the transmitter 390 in the MS and receiver 394 in the BS.

A diagram illustrating an example prior art multi-channel HARQ data and ACK/NACK transmission sequence for several ACID channels over a sequence of 11 frames is shown in FIG. 8. In this example, three multiple HARQ processes on three ACID channels 0, 1 and 2 send data to a receiver over a link. The data is shown in square boxes labeled B1, B2, etc. while the ACK/NACK responses are shown in the hexagon shaped symbols. Information unit received incorrectly generate a NACK which trigger a retransmission, as indicated in the Figure. For example, the information unit B1 transmitted on ACID 0 in frame 1 was received in error (indicated by NACK transmitted in frame 3). The retransmission of B1 in frame 5 is received correctly (indicated by the ACK in frame 7). Similarly, the information unit B3 transmitted on ACID 2 in frame 3 was received in error (indicated by NACK transmitted in frame 5). The retransmission of B3 in frame 7 is received correctly (indicated by the ACK in frame 9).

Prior art examples of WiMAX HARQ operation for the DL and UL are shown in FIGS. 9 and 10, respectively. Note that HARQ feedback is synchronous wherein the feedback channel is pre-allocated. Typically, if a burst is sent at Frame i, feedback will be available at Frame i+2. The UL ACK channel is specified by UL_HARQ ACK_IE. One slot is shared by two ACKs. The DL ACK channel is implicitly in the HARQ_Control_IE by toggling the AI_SN bit. The AI_SN bit is toggled whenever a transmission is successful.

With reference to FIG. 1, a WiMAX network (or any other cellular or multiple wireless access network) typically includes several base stations (BS) 12. An SU device 16, such as a mobile phone, is permitted to transmit in the uplink direction (i.e. the SU transmits while the BS receives) up to a maximum allowable rate or power previously communicated to the SU device by the BS.

As described supra, HARQ is an information transmission methodology used to improve transmission performance in the network. In stop-and-wait HARQ, used in many wireless networks such as WiMAX or UMTS, each HARQ entity incorporates several HARQ processes. Each HARQ transmit process includes a send buffer and related control logic that operates in accordance with the signaling messages received from the receiving entity, as shown in FIG. 3. One or more original data packets are assembled into transmit information units (i.e. transmission bursts, HARQ sub-bursts or simply bursts) and placed in the send buffer. The receiver functions to decode the received transmission bursts and provide a response to the transmitting entity indicating whether the next burst should be (1) a retransmission of the current burst or (2) a new information burst. In the case of the uplink, the SU transmits and the BS receives. Note that improved transmission performance is achieved by saving previous transmissions and using them in decoding any retransmissions. The penalty is additional processing and HARQ buffer space.

Typical signaling associated with HARQ protocols is the ACK/NACK indication 63 (FIG. 3). Upon receiving an ACK, the transmitting entity flushes its send buffer and places a new information burst for transmission. Thus, the HARQ processor is prevented from transmitting new information units in the same logical HARQ channel until the current information unit is transmitted and a specific or implicit ACK/NACK signaling message is received in response thereto. The SU stores the information unit sent over the uplink in a send buffer until the relevant information unit is successfully communicated to the BS. The send buffer in the SU is therefore used in connection with HARQ processes in the BS, in which the BS combines two or more similar or complementary copies of the same information unit, each copy possibly received in error, in order to correctly determine the information unit that was actually sent. Only when an information unit is successfully received by the BS, i.e. when the BS correctly determines the information unit that was sent, by possible combining of copies, does the SU remove the information unit from its send buffer.

Currently, the HARQ mechanism in WiMAX (i.e. IEEE 802.16e) and other wireless protocols is implemented through the definition of one or more HARQ sub-channel per link, service flows and connection. The HARQ process reconfiguration procedure re-maps the MAC flows (connection ID or CID), i.e. it reorganizes how data is to be mapped to physical channels, referred to as ACIDs (Atomicity, Consistency, Isolation, Durability). The send buffer is maintained by the physical layer per ACID or ACID group, i.e. the information units in the send buffer have already been passed to the physical layer. Since the HARQ buffer size is limited, this mechanism enables several service flows (or connections) to share a common resource. Moreover, in order to avoid the HARQ delay caused by the stop-and-wait HARQ scheme, one service flow (or connection) can be used for several ACID channels.

In the case of WiMAX (or other communication methodologies), the system may, from time to time, decide that an SU HARQ process send buffer need to be flushed (i.e. all information units in the buffer are to be removed). This need may occur in systems where the BS does not provide a direct indication (i.e. ACK) per buffer for successfully received information units. For example, an indication of successful receipt is given indirectly when a new opportunity to transmit information is allocated for the buffer. An indirect indication scheme is typically implemented to reduce the overhead of HARQ signaling. From time to time, however, the SU and BS may loose their send buffer status synchronization for one or more HARQ processes. This may occur, for example, when a signaling message is incorrectly decoded or fails to be decoded altogether. In this case, the SU will likely not perform any HARQ process buffer flushing, since it was never instructed to do so by the BS. In systems that implement an indirect ACK/NACK signaling scheme, by definition there are no means to solve the problem of the send buffer losing synchronization.

There is thus a need for a mechanism that is capable of enabling network elements on both ends of a communication link to initiate the flushing of their respective HARQ process buffers. The mechanism should provide the ability whereby the network elements are able to synchronize with each to provide a capability of flushing all or a part of HARQ transmit and receive buffers associated with one or more specific HARQ processes. The mechanism should permit a network element to initiate a flushing operation based on an internal algorithm or predefined configurable or negotiable parameters provided by another entity.

### SUMMARY OF THE INVENTION

Accordingly, the present invention provides a novel and useful buffer management and related signaling mechanism for use in a communications link. The invention is particularly useful in wireless telecommunication systems such as those adhering to IEEE 802.16 (WiMAX), 3GPP, 3GPP2, etc. communication standard specifications that utilize hybrid automatic repeat request (HARQ) protocol mechanisms, but is not limited to use with these systems.

The invention overcomes the problems associated with the prior art by enabling the SU or BS to initiate a HARQ buffer flushing event. The invention provides a mechanism by which an SU and a BS interface and negotiate between one another regarding HARQ buffer flushing. Either side may communicate buffer flushing configuration information which comprises a set of instructions for triggering and performing HARQ process buffer flushing. The SU (or BS) is operative to initiate such a flushing operation based on internal algorithms using predefined configurable and/or negotiable parameters received from the BS (or SU). The flushing operation may be performed on all or a part of the buffer (transmit and/or receive) or on certain complete or partial accumulated information.

Thus, the invention provides a buffer flushing and related signaling mechanism that enables network elements on both ends of a communication link to autonomously initiate coordinated or uncoordinated flushing of their respective HARQ process buffers based on internal algorithms and/or criteria previously negotiated between the two elements. The mechanism provides the capability for each network element to flush all or a part of its respective HARQ transmit and receive buffers associated with one or more specific HARQ processes. The mechanism permits a network element to initiate a flushing operation based on an internal algorithm or predefined configurable or negotiable parameters provided by another entity. The decision to flush a HARQ buffer can made in accordance with criteria provided in configuration messages and/or internal criteria. The contents of the flushing configuration messages may comprise any suitable criteria such as timeout data, parameters exceeding a threshold, data measurements exceeding a threshold, QoS level, CID/ACID priority, buffer occupancy, etc. which is used to trigger a buffer flushing event and characterize the flushing methodology.

To aid in illustrating the present invention, the buffer flushing mechanism is presented in the context of the transmission of HARQ sub-bursts between subscriber unit (SU) devices and a WiMAX (IEEE 802.16) radio access network (RAN) that incorporates hybrid automatic repeat request (HARQ) flushing.

The buffer management and signaling mechanism of the present invention is suitable for use in many types of wired and wireless communication systems. For example, the mechanism is applicable to broadband wireless access (BWA) systems and cellular communication systems, particularly OFDM based systems. An example of a broadband wireless access system the mechanism of the present invention is applicable to is the well known WiMAX wireless communication standard. The mechanism of the invention is also applicable to one of the third-generation (3G) mobile phone technologies known as 3GPP-LTE, Universal Mobile Telecommunications System (UMTS), Code Division Multiple Access (CDMA), Enhanced Data rates for GSM Evolution (EDGE) and Wireless Local Area Network (WLAN) wireless communication systems. The invention is also applicable to fourth generation (4G) mobile technologies, Digital Video Broadcasting (DVB) standards, Ultra Wideband (UWB), Ultra Mobile Broadband (UMB) and IEEE 802.11n/g/a.

Many aspects of the invention described herein may be constructed as software objects that execute in embedded devices as firmware, software objects that execute as part of a software application on either an embedded or non-embedded computer system running a real-time operating system such as Windows mobile, WinCE, Symbian, OSE, Embedded LINUX, etc., or non-real time operating systems such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a method of buffer flushing for use over a communications link, the method comprising the step of configuring a communication device coupled to the link with buffer flushing criteria that if met, triggers a buffer flushing operation in the communication device.

There is also provided in accordance with the invention, a method of buffer flushing signaling for use in subscriber unit (SU) device within a radio access network (RAN), the method comprising the steps of receiving a buffer flushing message from the RAN comprising buffer flushing criteria and configuring the SU device in accordance with the buffer flushing criteria.

There is further provided in accordance with the invention, a method of buffer flushing signaling for use in a radio access network (RAN) element, the method comprising the step of transmitting a buffer flushing configuration message comprising buffer flushing criteria to a subscriber unit (SU) device, wherein a buffer flushing operation is triggered in the SU device if the criteria is met.

There is also provided in accordance with the invention, an apparatus for buffer flushing signaling in a radio access network (RAN) comprising a communications buffer, a buffer controller coupled to the buffer and operative to execute a hybrid automatic repeat request (HARQ) protocol, receiving means for receiving a buffer flushing configuration message and configuration means for configuring the buffer controller in accordance with the buffer flushing configuration message.

There is further provided in accordance with the invention, a subscriber unit (SU) device coupled to a radio access network (RAN) comprising a transmitter, a receiver, a baseband processor coupled to the transmitter and the receiver, a hybrid automatic repeat request (HARQ) module coupled to the baseband processor, the HARQ module comprising a communications buffer, a buffer controller coupled to the buffer and operative to execute a hybrid automatic repeat request (HARQ) protocol, receiving means for receiving buffer flushing criteria from the RAN and configuration means for configuring the buffer controller in accordance with the buffer flushing criteria such that the buffer controller triggers a flushing operation of the communications buffer when the criteria is met.

### BRIEF DESCRIPTION OF THE DRAWINGS

The invention is herein described, by way of example only, with reference to the accompanying drawings, wherein:

FIG. 1 is a diagram illustrating the prior art HARQ process with incremental redundancy;

FIG. 2 is a diagram illustrating the generation of HARQ sub-bursts from multiple MAC PDUs;

FIG. 3 is a high level block diagram illustrating an example prior art HARQ mechanism;

FIG. 4 is a diagram illustrating an example prior art multiple access wireless communications system;

FIG. 5 is a block diagram illustrating a conventional OFDMA transceiver;

FIG. 6 is a diagram illustrating an example prior HARQ mechanism;

FIG. 7 is a block diagram illustrating an example prior art HARQ transmit and receive system;

FIG. 8 is a diagram illustrating an example prior art HARQ data and ACK/NACK transmission sequence;

FIG. 9 is a diagram illustrating WiMAX DL HARQ operation message flow;

FIG. 10 is a diagram illustrating WiMAX UL HARQ operation message flow;

FIG. 11 is a general block diagram illustrating an example user equipment (UE) device incorporating the HARQ buffer flushing mechanism of the present invention;

FIG. 12 is a general block diagram illustrating a mobile station incorporating the HARQ buffer flushing mechanism of the present invention;

FIG. 13 is a diagram illustrating an example implementation of the HARQ buffer flushing mechanism between an example BS/RAN and SU device;

FIG. 14 is a diagram illustrating the frame structure of an example OFDMA frame adapted for use with the HARQ buffer flushing signaling mechanism of the present invention;

FIG. 15 is a flow diagram illustrating the BS initiated HARQ buffer flushing method of the present invention;

FIG. 16 is a flow diagram illustrating the BS initiated HARQ buffer flushing method of the present invention;

FIG. 17 is a flow diagram illustrating the receiver based control channel signaling method of the present invention;

FIG. 18 is a diagram illustrating an example WiMAX receiver incorporating the HARQ buffer flushing mechanism of the present invention; and

FIG. 19 is a diagram illustrating an example WiMAX transmitter incorporating the HARQ buffer flushing mechanism of the present invention.

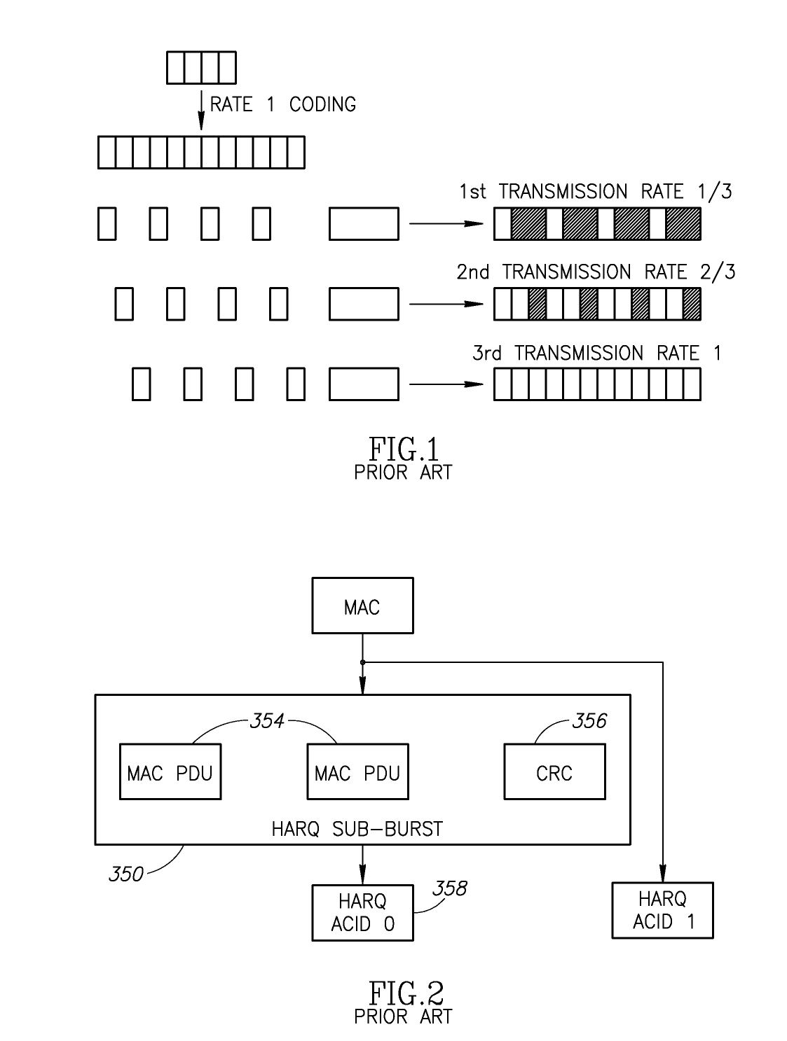

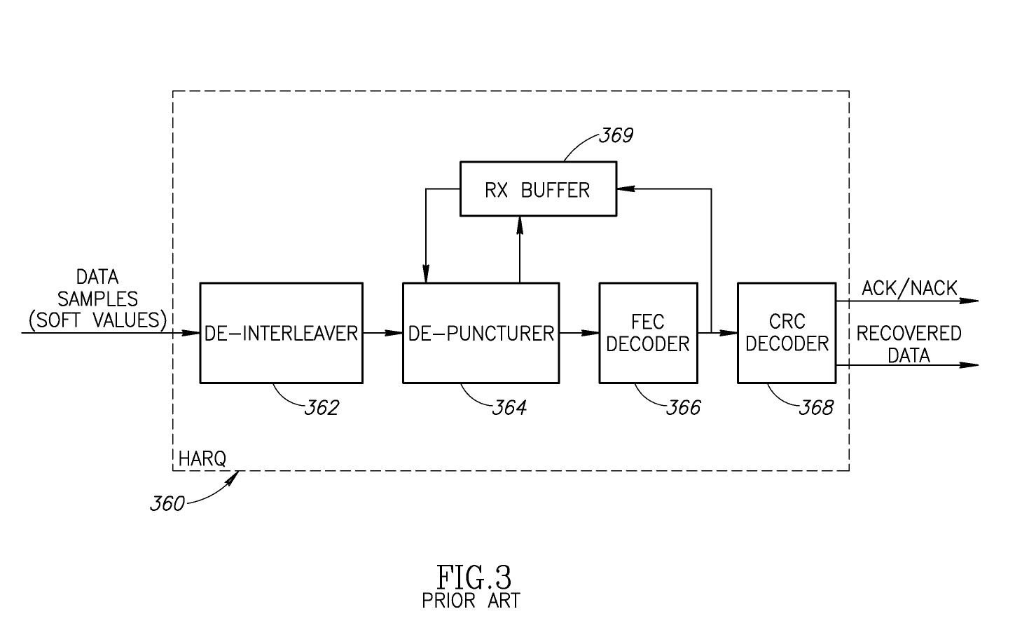

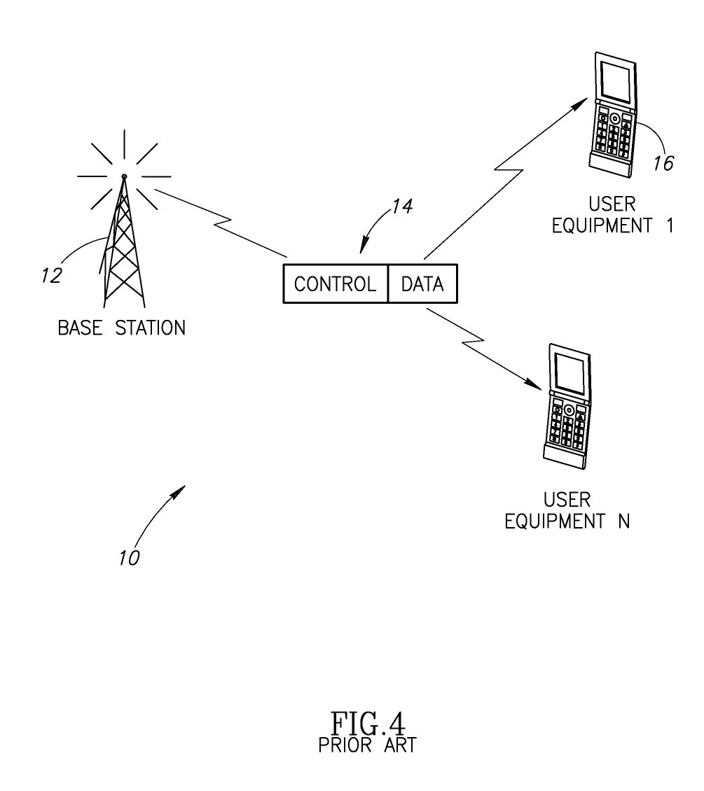

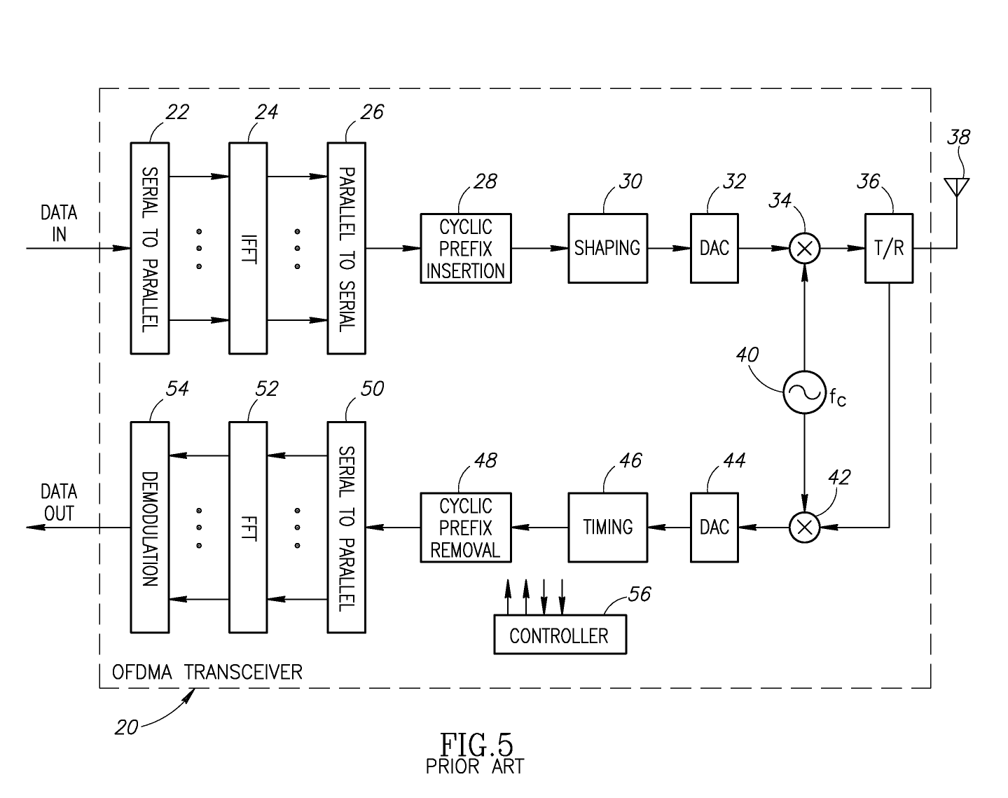

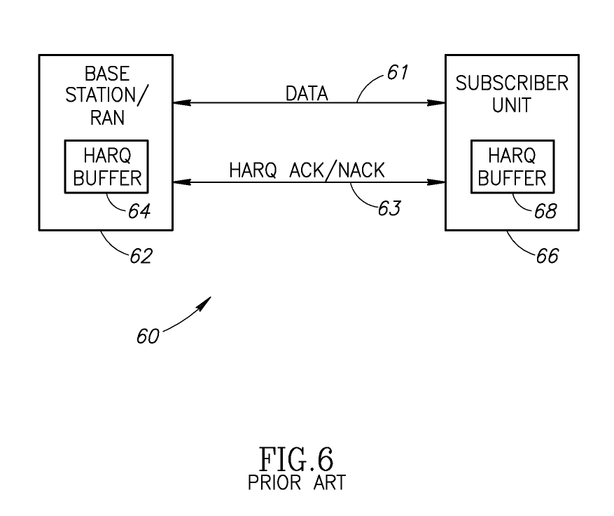

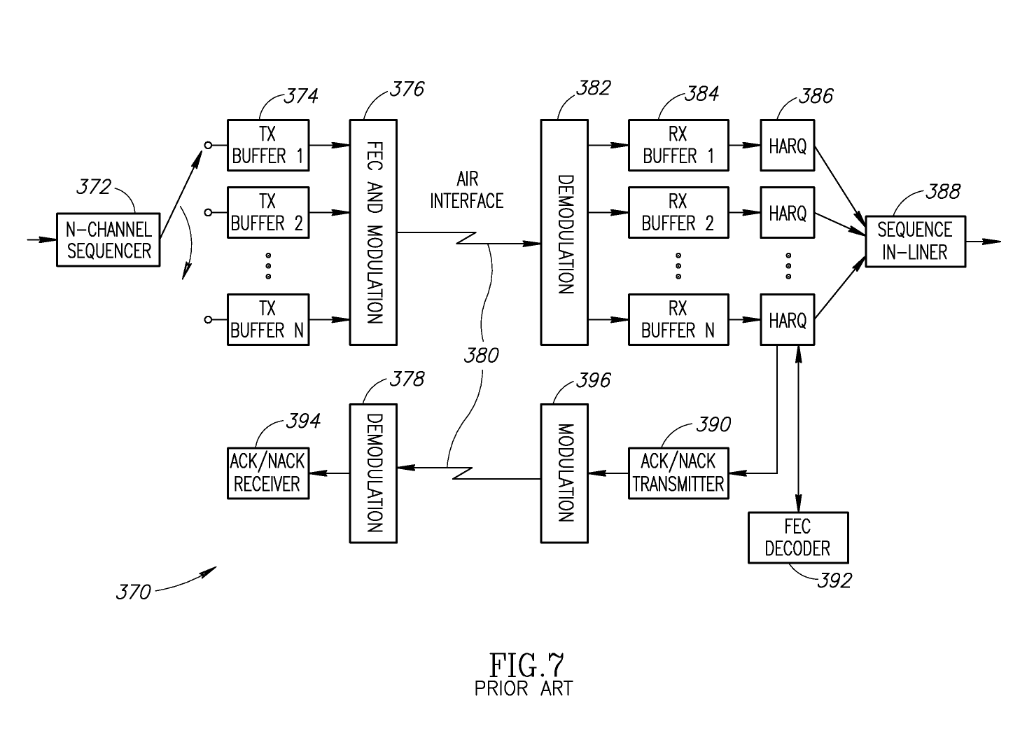

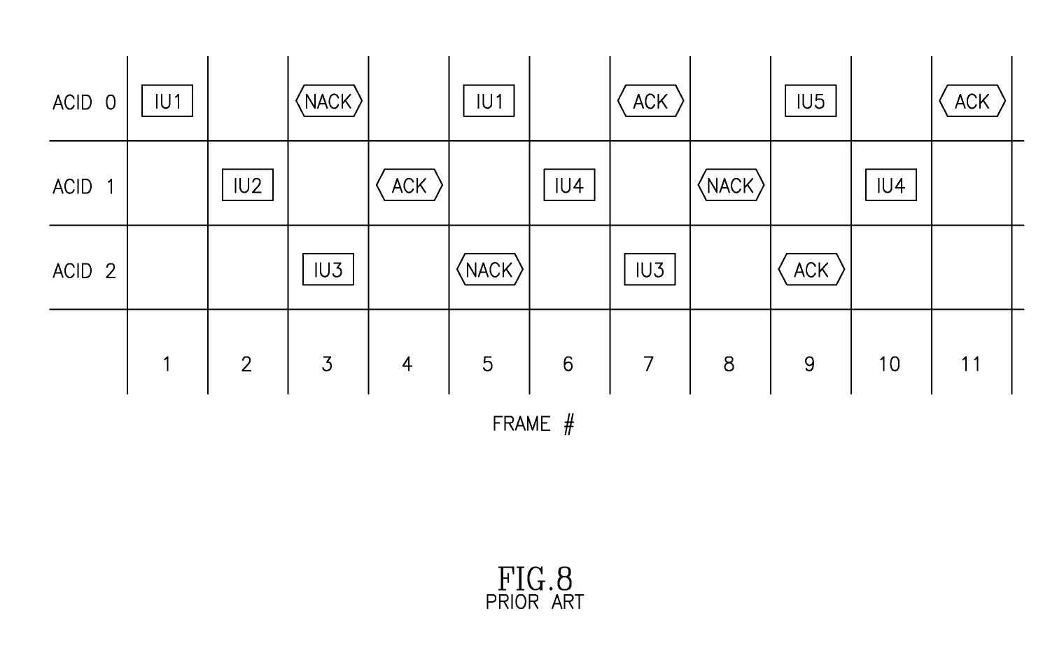

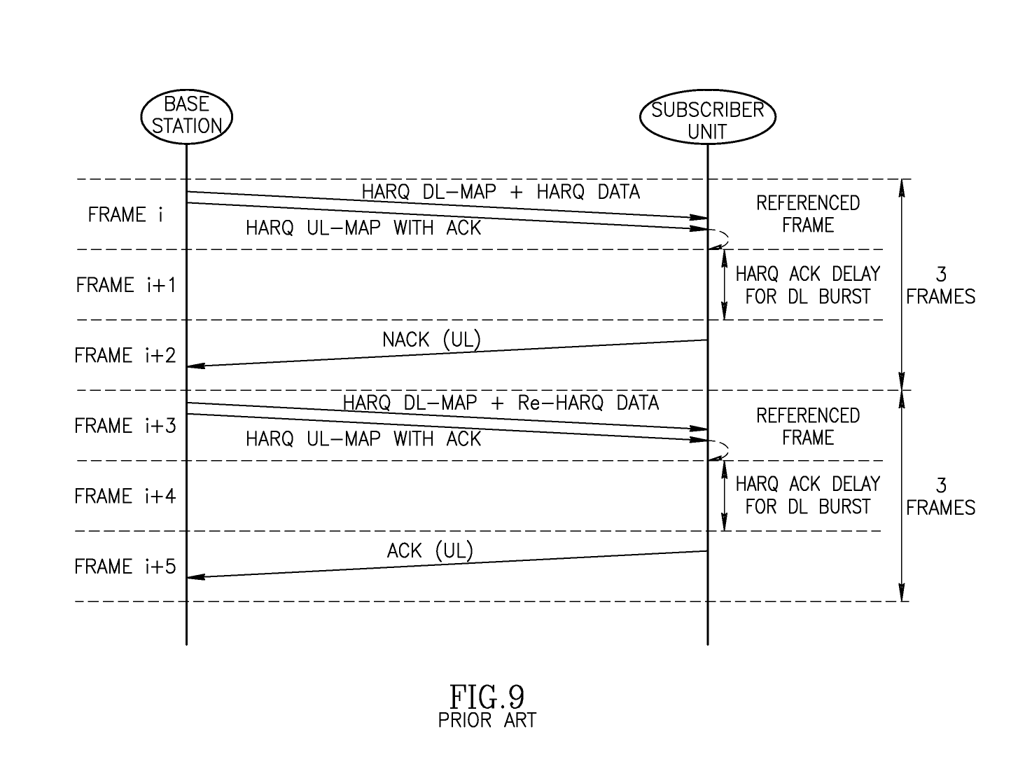

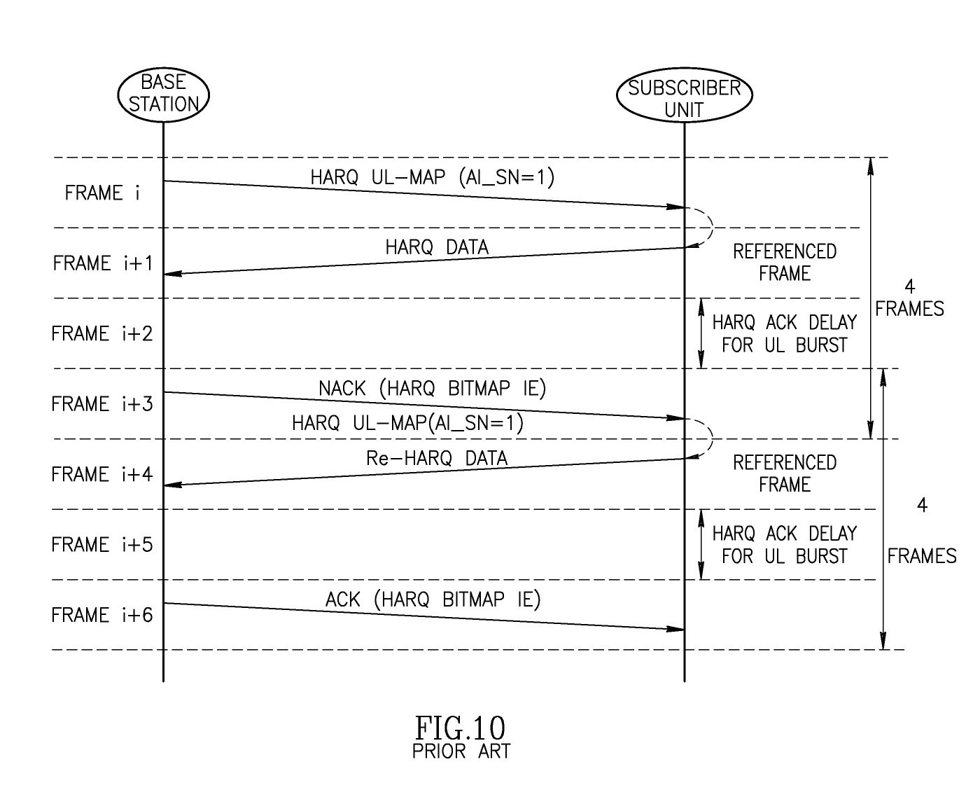

### DETAILED DESCRIPTION OF THE INVENTION

### Notation Used Throughout

The following notation is used throughout this document.

| Term | Definition |
|---|---|
| 3GPP | 3^{rd} Generation Partnership Project |
| AAA | Authentication Authorization and Accounting |
| AAS | Advance Antenna System |
| AC | Alternating Current |
| ACID | Atomicity, Consistency, Isolation, Durability |
| ADC | Analog to Digital Converter |
| ARQ | Automatic Repeat Request |
| ASIC | Application Specific Integrated Circuit |
| AVI | Audio Video Interface |
| BMP | Windows Bitmap |
| BWA | Broadband Wireless Access |
| CDMA | Code Division Multiple Access |
| CID | Connection ID |
| CINR | Carrier to Interference-plus-Noise Ratio |
| CP | Cyclic Prefix |
| CPU | Central Processing Unit |
| CQI | Channel Quality Indicator |
| CRC | Cyclic Redundancy Check |
| DAC | Digital to analog Converter |
| DC | Direct Current |
| DL | Downlink |
| DRAM | Dynamic Random Access Memory |
| DVB | Digital Video Broadcast |
| ECC | Error Correction Code |
| ED | Error Detection |
| EDGE | Enhanced Data rates for GSM Evolution |
| EEPROM | Electrically Erasable Programmable Read Only Memory |
| EGPRS | Enhanced General Packet Radio Service |
| EPROM | Erasable Programmable Read Only Memory |
| EVDO | Evolution-Data Optimized |
| FDD | Frequency Division Duplex |
| FEC | Forward Error Correction |
| FEM | Front End Module |
| FFT | Fast Fourier Transform |
| FM | Frequency Modulation |
| FPGA | Field Programmable Gate Array |
| GPRS | General Packet Radio Service |
| GPS | Global Positioning Satellite |
| GSM | Global System for Mobile Communication |
| HARQ | Hybrid Automatic Repeat Request |
| HDL | Hardware Description Language |
| ID | Identification |
| IE | Information Element |
| IEEE | Institute of Electrical and Electronic Engineers |
| IFFT | Inverse Fast Fourier Transform |
| IR | Incremental Redundancy |
| ISI | Intersymbol Interference |
| JPG | Joint Photographic Experts Group |
| KPI | Key Performance Indicators |
| LAN | Local Area Network |
| LSB | Least Significant Bit |
| MAC | Media Access Control |
| MIMO | Multiple In Multiple Out |
| MP3 | MPEG-1 Audio Layer 3 |
| MPG | Moving Picture Experts Group |
| MCS | Modulation and Coding Schemes |
| MS | Mobile Station |
| MSB | Most Significant Bit |
| OFDMA | Orthogonal Frequency Division Multiple Access |
| OSI | Open System Interconnect |
| PC | Personal Computer |
| PCI | Peripheral Component Interconnect |
| PDA | Personal Digital Assistant |
| PDU | Protocol Data Unit |
| PER | Packet Error Rate |
| QAM | Quadrature Amplitude Modulation |
| QPSK | Quadrature Phase Shift Keying |
| RAM | Random Access Memory |
| RAN | Radio Access Network |
| RAT | Radio Access Technology |
| RLC | Radio Link Control |
| RF | Radio Frequency |
| ROM | Read Only Memory |
| RSSI | Received Signal Strength Indication |
| SDIO | Secure Digital Input/Output |
| SIM | Subscriber Identity Module |
| SNR | Signal to Noise Ratio |
| SPI | Serial Peripheral Interface |
| SRAM | Static Read Only Memory |
| STC | Space Time Coding |
| SU | Subscriber Unit |
| T/R | Transmitter/Receiver |
| TDD | Time Division Duplex |
| TLV | Type, Length, Value |
| TV | Television |
| UE | User Equipment |
| u-ID | User (or group of users) Identification code |
| UL | Uplink |
| UMB | Ultra Mobile Broadband |
| UMTS | Universal Mobile Telecommunications System |
| USB | Universal Serial Bus |
| UTRA | Universal Terrestrial Radio Access |
| UWB | Ultra Wideband |
| WCDMA | Wideband Code Division Multiple Access |
| WiFi | Wireless Fidelity |
| WiMAX | Worldwide Interoperability for Microwave Access |
| WiMedia | Radio platform for UWB |
| WLAN | Wireless Local Area Network |
| WMA | Windows Media Audio |
| WMV | Windows Media Video |
| WPAN | Wireless Personal Area Network |

### DETAILED DESCRIPTION OF THE INVENTION

The present invention provides a novel and useful buffer management and related signaling mechanism for use in a communications link. The invention is particularly useful in wireless telecommunication systems such as those adhering to IEEE 802.16 (WiMAX), 3GPP, 3GPP2, etc. communication standard specifications that utilize hybrid automatic repeat request (HARQ) protocol mechanisms, but is not limited to use with these systems.

Thus, the invention provides a buffer flushing and related signaling mechanism that enables network elements on both ends of a communication link to autonomously initiate the flushing of their respective HARQ process buffers based on criteria previously negotiated between the two elements, configured in the elements and/or internal algorithms implemented at one or both sides of the link. The mechanism provides the capability for each network element to flush all or a part of its respective HARQ transmit and receive buffers associated with one or more specific HARQ processes. The mechanism permits a network element to initiate a flushing operation based on an internal algorithm or predefined configurable or negotiable parameters provided by another entity. The decision to flush a HARQ buffer is made in accordance with criteria provided in configuration messages. The contents of the configuration messages may comprise any suitable criteria such as, for example, timeout data, parameters exceeding a threshold, data measurements exceeding a threshold, QoS level, CID/ACID priority, buffer occupancy, etc. which is used to trigger a buffer flushing event.

The buffer management and signaling mechanism of the present invention is suitable for use in many types of wired and wireless communication systems. For example, the mechanism is applicable to broadband wireless access (BWA) systems and cellular communication systems, particularly OFDM based systems. An example of a broadband wireless access system the mechanism of the present invention is applicable to is the well known WiMAX wireless communication standard. The mechanism of the invention is also applicable to one of the third-generation (3G) mobile phone technologies known as 3GPP-LTE, Universal Mobile Telecommunications System (UMTS), Code Division Multiple Access (CDMA), Enhanced Data rates for GSM Evolution (EDGE) and Wireless Local Area Network (WLAN) wireless communication systems. The invention is also applicable to fourth generation (4G) mobile technologies, Digital Video Broadcasting (DVB) standards, Ultra Wideband (UWB), Ultra Mobile Broadband (UMB) and IEEE 802.11g/a.

To aid in illustrating the present invention, the buffer flushing mechanism is presented in the context of the transmission of HARQ sub-bursts between subscriber unit (SU) devices and a WiMAX (IEEE 802.16) radio access network (RAN) that incorporates hybrid automatic repeat request (HARQ) flushing. It is not intended that the scope of the invention be limited to the examples presented herein. One skilled in the art can apply the principles of the present invention to numerous other types of communication systems as well (wireless and non-wireless) without departing from the scope of the invention.

Note that throughout this document, the term communications transceiver or device is defined as any apparatus or mechanism adapted to transmit, receive or transmit and receive information through a medium. The communications device or communications transceiver may be adapted to communicate over any suitable medium, including wireless or wired media. Examples of wireless media include RF, infrared, optical, microwave, UWB, Bluetooth, WiMAX, GSM, EDGE, UMTS, WCDMA, 3GPP-LTE, CDMA-2000, EVDO, EVDV, UMB, WiFi, or any other broadband medium, radio access technology (RAT), etc. Examples of wired media include twisted pair, coaxial, optical fiber, any wired interface (e.g., USB, Firewire, Ethernet, etc.).

The terms communications channel, link and cable are used interchangeably. The terms mobile station (MS), user equipment (UE) and subscriber unit (SU) are defined as all user equipment circuitry and associated software needed for communication with a network such as a RAN (e.g., base stations). The terms mobile station, user equipment and subscriber unit are also intended to denote other devices including, but not limited to, a multimedia player, mobile communication device, cellular telephone, node in a broadband wireless access (BWA) network, smartphone, PDA, wireless LAN (WLAN), computer equipped with a mobile terminal device and Bluetooth device. Although a mobile station or user equipment are normally intended to be used in motion or while halted at unspecified points but, the terms as used herein also refers to devices fixed in their location. The term u-ID (i.e. user ID) refers to information representing the identity of a user or group of users. The term information unit is intended to refer to a packet, frame, transmission burst, burst, protocol data unit (PDU). A HARQ sub-burst or simply sub-burst is the term used in the IEEE 802.16e standard for an information unit. The sub-burst is transmitted within a frame and has a particular duration and slot allocation. A sub-burst may transport one or more packets, PDUs, etc.

The term HARQ refers to a communication scheme whereby the transmitter and receiver, on opposite ends of a communications link, cooperate on an information unit, packet, frame, sub-burst, burst, information element, transmission element or block level. The receiver end is capable of indicating successful (ACK) or unsuccessful (NACK) reception of the last transmitted information unit, block or packet. In HARQ processes, the receiver decodes the packet or block based on information gathered from all previous retransmissions of the same block thus improving overall performance of the link.

The word ‘exemplary’ is used herein to mean ‘serving as an example, instance, or illustration.’ Any embodiment described herein as ‘exemplary’ is not necessarily to be construed as preferred or advantageous over other embodiments.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.) and/or other content widely identified as multimedia. The user input means is typically formed of one or more manually operated switches, buttons, wheels or other user input means. Examples of multimedia devices include pocket sized personal digital assistants (PDAs), personal media player/recorders, cellular telephones, handheld devices, and the like.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### Radio Incorporating the HARQ Buffer Management Mechanism

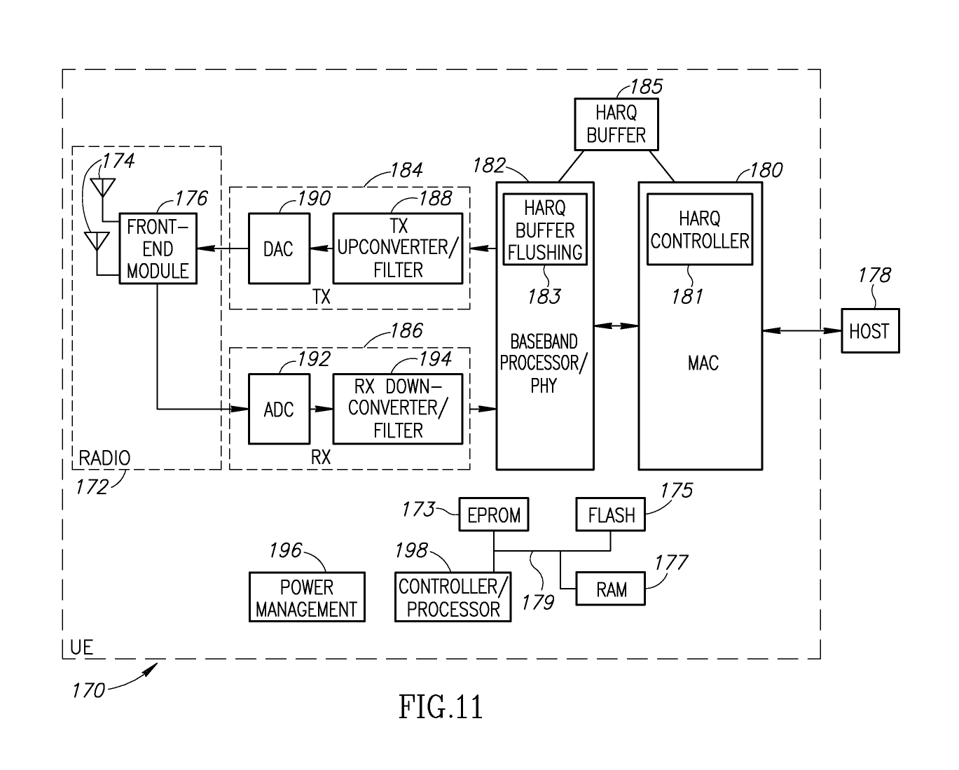

A general block diagram illustrating an example UE device incorporating the HARQ buffer flushing mechanism of the present invention is shown in FIG. 11. The UE, generally referenced 170, comprises a radio block 172 comprising RF front end module (FEM) 176 coupled to one or more antennas 174 (typically at least two in BWA systems), transmitter block 184 and dual receiver block 186 coupled to the FEM 176 and baseband processor/PHY 182, MAC 180 comprising HARQ controller 181, HARQ buffer(s) 185, power management block 196, a controller/processor 198 coupled to ROM memory 173, Flash 175 and RAM 177. The transmitter block 184 comprises TX upconversion and filtering block 188 and DAC 190. The receiver block 186 comprises ADC block 192 and RX downconversion and filtering block 194.

A host interface (not shown) functions to interface the UE via the MAC to a host entity 178. The host may comprise any suitable computing device such as a PDA, laptop computer, desktop computer, handheld telecommunications device, etc. The host interface may be adapted to communicate with the host in any manner. Typically, the host interface is adapted to communicate via a standard interface including, but not limited to, PCI, CardBus, USB, SDIO, SDI, etc.

The media access controller (MAC) 180 is operative to provide Layer 2 functionality. The main services and functions of the MAC sublayer includes mapping between logical and transport channels, multiplexing and demultiplexing of radio link control (RLC) PDUs belonging to one or different radio bearers into/from transport blocks (TB) delivered to/from the physical layer on transport channels, traffic volume measurement reporting, error correction through HARQ, priority handling between logical channels of one UE, priority handling between UEs by means of dynamic scheduling and transport format selection. The baseband processor/PHY module 182 performs modulation and demodulation of data (i.e. OFDM in the case of WLAN 802.11n/a/g, WiMAX, UWB, etc. capable radio). The baseband processor also handles the transmission and reception of frames to and from the TX and RX, respectively. Analog to digital (ADC) and digital to analog (DAC) conversion are performed in the receiver and transmitter, respectively. The FEM 176, coupled to antenna 174, performs radio frequency (RF) processing including filtering, optional down-conversion and up-conversion and amplification of the RF signal.

In accordance with the present invention, the buffer flushing mechanism of the present invention is implemented in the radio. Depending on the particular implementation, the HARQ buffer flushing mechanism (block 183) may be implemented in the baseband processor/PHY block 182, the MAC 180, as a task adapted to execute on the controller 198, or any combination thereof. For illustration purposes only, the HARQ buffer flushing mechanism is shown incorporated in the MAC and/or the PHY. It is appreciated that the HARQ buffer flushing mechanism may be implemented in other components of the radio as well without departing from the spirit of the invention. In the case the mechanism of the invention is implemented as a task executed on the processor/controller, the programming code for implementing the mechanism may reside in memories 173, 175 or 177 within the radio or in internal memory within the processor/controller 198 itself. Note also that the mechanism may be performed entirely in hardware, software or a combination of hardware and software. Alternatively, the mechanism may be implemented entirely in the host or a portion implemented in the host and a portion in the MAC.

The processor/controller 198 in the radio is coupled to flash memory 175, static random access memory (SRAM) 177 and electrical erasable programmable read only memory (EEPROM) 173. Note that DRAM may be used in place of static RAM. The controller 198 is operative to provide management, administration and control to the MAC, baseband processor, PHY and TX, RX modules. The controller is also in communication with the Flash, SRAM and EEPROM memories via a memory bus 179 or via a single bus (not shown) shared by all the modules and memory devices.

### Mobile Station Incorporating the HARQ Buffer Flushing Mechanism

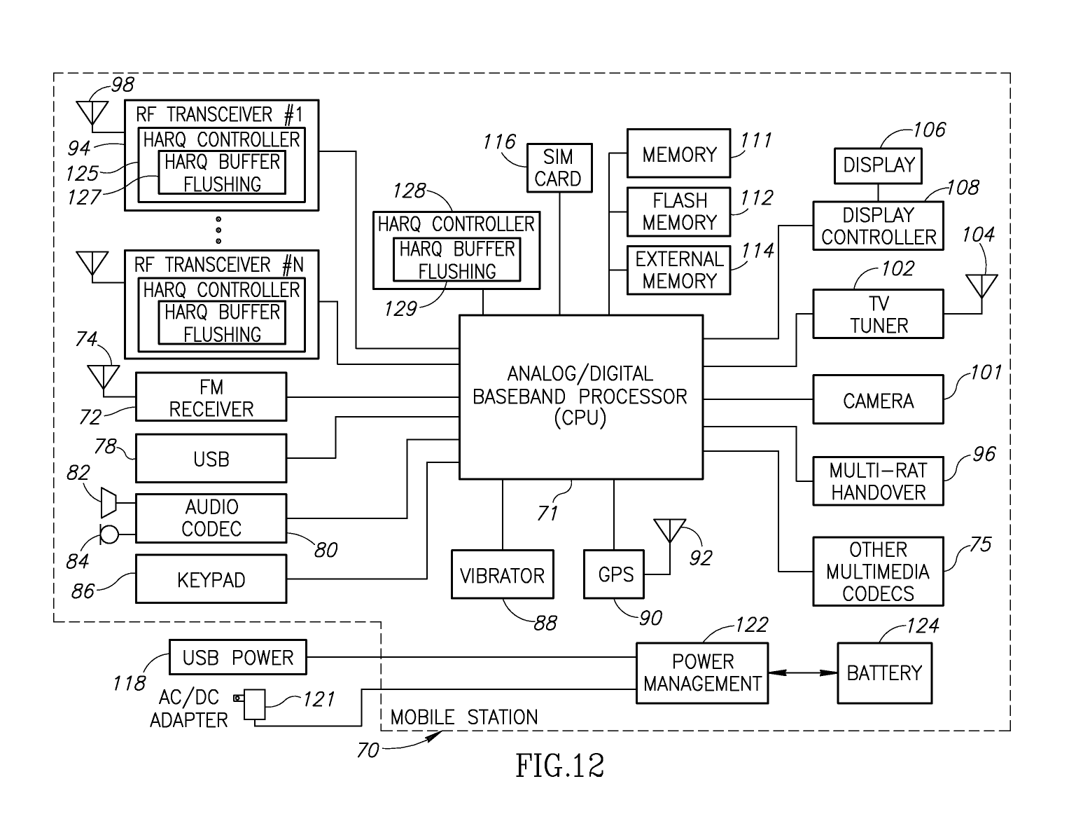

A general block diagram illustrating a mobile station (MS) incorporating the HARQ buffer flushing mechanism of the present invention is shown in FIG. 12. Note that the mobile station (also referred to as user equipment) may comprise any suitable wired or wireless device such as multimedia player, mobile communication device, cellular phone, smartphone, PDA, Bluetooth device, etc. For illustration purposes only, the device is shown as a mobile station. Note that this example is not intended to limit the scope of the invention as the HARQ buffer flushing mechanism of the present invention can be implemented in a wide variety of communication devices.

The mobile station, generally referenced 70, comprises a baseband processor or CPU 71 having analog and digital portions. The MS may comprise a plurality of RF transceivers 94 and associated antennas 98. RF transceivers for the basic cellular link and any number of other wireless standards and RATs may be included. Examples include, but are not limited to, Global System for Mobile Communication (GSM)/GPRS/EDGE 3G; CDMA; WiMAX for providing WiMAX wireless connectivity when within the range of a WiMAX wireless network using OFDMA techniques; Bluetooth for providing Bluetooth wireless connectivity when within the range of a Bluetooth wireless network; WLAN for providing wireless connectivity when in a hot spot or within the range of an ad hoc, infrastructure or mesh based wireless LAN network; near field communications; 60G device; UWB; etc. One or more of the RF transceivers may comprise an additional a plurality of antennas to provide antenna diversity which yields improved radio performance. The mobile station may also comprise internal RAM and ROM memory 110, Flash memory 112 and external memory 114.

Several user interface devices include microphone(s) 84, speaker(s) 82 and associated audio codec 80 or other multimedia codecs 75, a keypad for entering dialing digits 86, vibrator 88 for alerting a user, camera and related circuitry 100, a TV tuner 102 and associated antenna 104, display(s) 106 and associated display controller 108 and GPS receiver 90 and associated antenna 92. A USB or other interface connection 78 (e.g., SPI, SDIO, PCI, etc.) provides a serial link to a user's PC or other device. An FM receiver 72 and antenna 74 provide the user the ability to listen to FM broadcasts. SIM card 116 provides the interface to a user's SIM card for storing user data such as address book entries, etc. Note that the SIM card shown is intended to represent any type of smart card used for holding user related information such as identity and contact information, Authentication Authorization and Accounting (AAA), profile information, etc. Different standards use different names, for example, SIM for GSM, USIM for UMTS and ISIM for IMS and LTE.

The mobile station comprises HARQ controller blocks 125 including HARQ buffer flushing blocks 127 which may be implemented in any number of the RF transceivers 94. Alternatively (or in addition to), the HARQ controller block 128 including buffer flushing block 129 may be implemented as a task executed by baseband processor 71. The HARQ buffer flushing blocks 127, 129 are adapted to implement the HARQ buffer flushing mechanism of the present invention as described in more detail infra. In operation, the HARQ buffer flushing blocks may be implemented as hardware, software or as a combination of hardware and software. Implemented as a software task, the program code operative to implement the HARQ buffer flushing mechanism of the present invention is stored in one or more memories 110, 112 or 114 or local memories within the baseband processor.

Portable power is provided by the battery 124 coupled to power management circuitry 122. External power is provided via USB power 118 or an AC/DC adapter 120 connected to the battery management circuitry which is operative to manage the charging and discharging of the battery 124.

### HARQ Buffer Flushing and Signaling Mechanism

In one embodiment of the present invention, a HARQ buffer flushing and related signaling mechanism is provided that is intended to be implemented on both ends of a communications link. For illustration purposes, consider an SU device and BS/RAN modified to implement the mechanism of the present invention. In operation, the SU device parses messages sent from a radio access network (RAN) such as WiMAX. The messages comprise (1) an indication to determine whether a retransmission of a previously sent information unit or a new transmission is requested from the BS, (2) information required to configure and negotiate a set of parameters, or (3) an indication to the SU to flush the HARQ buffer or a part thereof based on certain criteria without the need for a direct flushing indication. The mechanism includes a set of messages to indicate when the SU device is to flush one or more buffers (or a part thereof).

Correspondingly, the SU device is directed by the BS to perform HARQ process flushing based on certain predefined criteria. The configuration information, which comprises instructions/commands for triggering and performing HARQ process buffer flushing, can be negotiated by the SU even it is initially provided by the BS. This provides a means whereby the SU and BS interface and collaborate in respect to HARQ buffer flushing. Based on the contents of the configuration information (i.e. a predefined set of parameters and procedures), the SU triggers and performs HARQ process buffer flushing.

The invention also provides transmitter and receiver circuitry for use in an SU device and BS/RAN that is operative to implement the mechanism of the invention, as described in more detail infra. Additionally, a computer program product operative to implement the mechanism of the invention when executed by an SU device (or BS/RAN) is also provided. Further, in alternative embodiments, the mechanisms of the invention may be adapted to be implemented in ASICs and FPGAs.

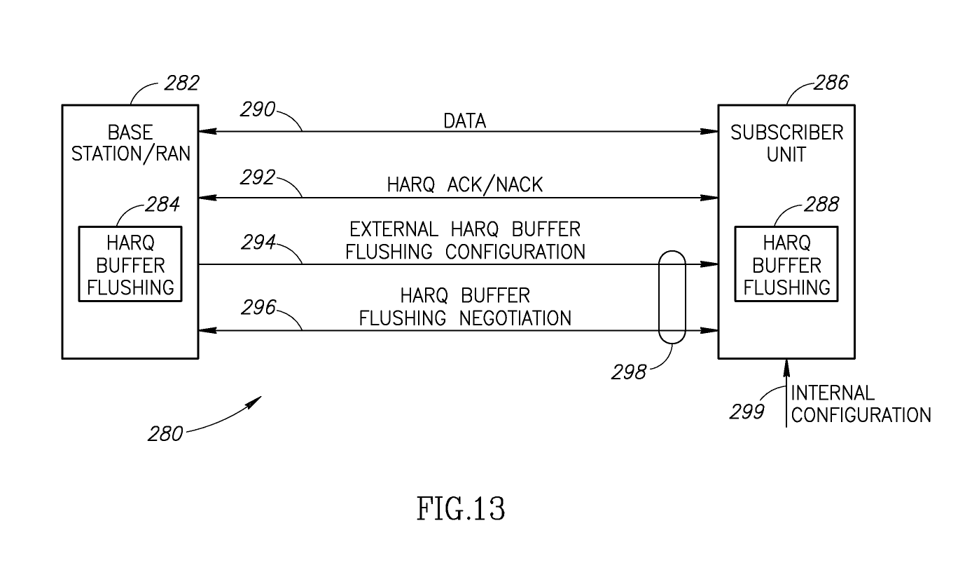

A diagram illustrating an example implementation of the HARQ buffer flushing negotiation mechanism between an example BS/RAN and SU device is shown in FIG. 13. The example communications system, generally referenced 280, comprises a base station (BS) or radio access network (RAN) 282 comprising HARQ buffer flushing block 284 (incorporating a HARQ transmit and/or receive buffer) on one end of a communication link and a subscriber unit (SU) 286 comprising HARQ buffer flushing block 288 (incorporating a HARQ transmit and/or receive buffer). The buffers (transmit and/or receive) may comprise buffers used in HARQ processes for WiMAX, i.e. buffers used to store information units for possible retransmission to one or more BSs to which the SU is communicatively coupled.

The SU device 286 comprises a mobile phone or other wireless terminal, mobile or otherwise, and is communicatively coupled to the wireless network via the radio access network. The wireless network 280 includes a core network communicatively coupled to one or more base stations through a radio access network (RAN) 282. The RAN comprises one or more base stations and other RAN elements along with the functionality to connect, transfer and control these elements and the base stations. Each BS wirelessly interacts with wireless terminals 286 (i.e. SUs). The receivers and transmitters on either end of the link communicate the following between each other: data 290, HARQ ACK/NACK signaling 292 and HARQ buffer flushing related information 298. The HARQ buffer flushing related information 298 comprises external HARQ buffer flushing configuration related information 294 and HARQ buffer flushing negotiation information 298.

In accordance with conventional HARQ processing, the transmitter in each device typically comprises several HARQ processors, each of which performs operations of transmitting information units, receiving ACK/NACK information or other ACK indications in response thereto and performing either a retransmission when needed or transmitting the next information unit. Normally, a HARQ processor cannot transmit additional information units until it receives specific or implicit ACK/NACK information in response to a transmitted information unit. The ACK indication may be direct, i.e. to send a specific ACK or NACK indication or may be implicit, i.e. to send a request to either transmit the next information unit or retransmit the last information unit.

In addition to the conventional HARQ functionality, the mechanism of the present invention provides a solution for the situation that arises when the send (or receiver) buffers associated with one or more HARQ processes in the SU and BS lose synchronization with one another. As discussed supra, this may occur due to a signaling message being decoded incorrectly or not at all, resulting in the HARQ process not being flushed since it never received instructions to do so. Note that loss of synchronization may also occur when using implicit ACK/NACK.

With reference to FIG. 13, in this example, the SU device 286 receives a message 294 from the Radio Access Network (RAN) 282 which comprises a Radio Network Controller (RNC) and the BS, the message indicating that the SU is to perform HARQ process buffer flushing in accordance with the invention. Note that the configuration information may be provided (1) externally from the device on the other end of the link via a configuration message 294 or (2) internally 299 from internal configuration generating processes implemented in the SU device itself.

Note that the HARQ buffer flushing configuration/reconfiguration messaging (294) or negotiation messaging (296) is an example of a reconfiguration message that conveys the flushing criteria to be used to determine when a send (or receive) buffer is to be flushed. The criteria may comprise, for example, a timer value or measurement threshold, frequency, SNR, link level, etc. The actual criteria or indication used is not critical to the invention. The buffer flushing action resulting from the criteria is, however, critical.

In operation, the BS 282 (or any other component of a wireless network) communicates with the SU device 286 transferring data 290 using the HARQ protocol 292. Either before or during the establishment of the connection, the BS configures the SU device with the relevant parameters for managing HARQ buffer flushing (294). The configuration messages provides instructions and indications to the internal HARQ procedure on the SU device for flushing a HARQ buffer (transmit and/or receive) storing information units for sending to or receiving from the wireless network.

In accordance with the invention, the SU device may negotiate the configuration indications and parameters based on one or more negotiation procedures (296). The buffer flushing procedure may be also affected by the currently active internal configuration state (299). The results of the negotiation procedures may indicate to the SU device that all or a part of a send (or receive) buffer is to be flushed.

As an example of the buffer flushing mechanism, consider the transmission of real-time data from the BS to the SU. Such real-time data has a certain time window such that it is not relevant or useful anymore if a certain amount time has elapsed from the time of its first transmission. If this amount of time has in fact elapsed, than it is desirable to have the SU device perform a buffer flushing operation to clear out the stale data.

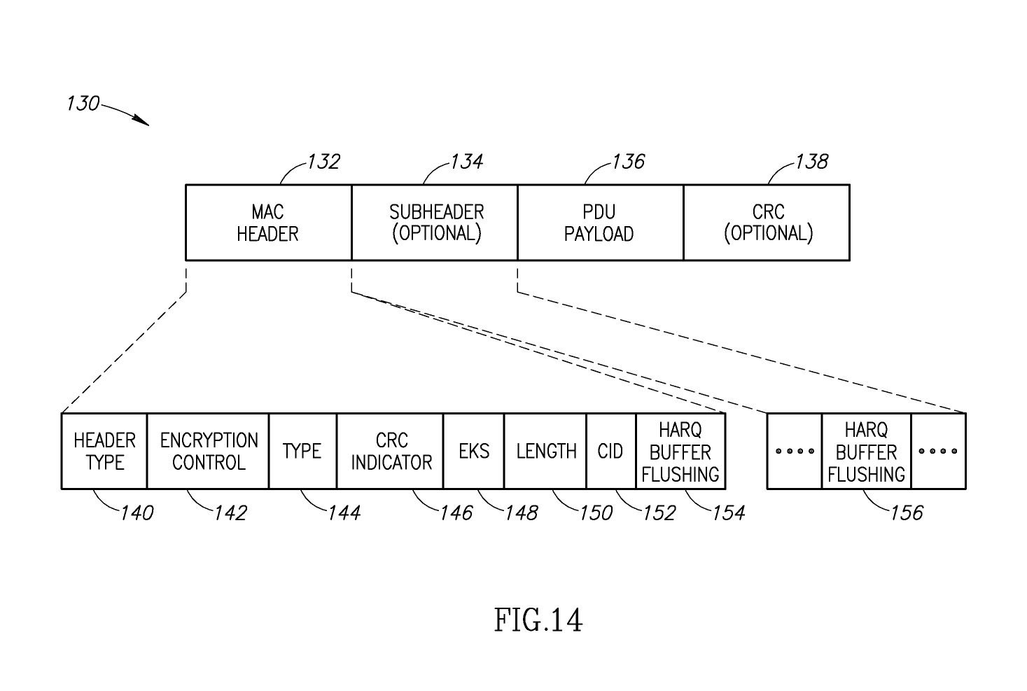

A diagram illustrating the structure of an example control message adapted for use with the HARQ buffer flushing signaling mechanism of the present invention is shown in FIG. 14. In this example embodiment, the conventional HARQ signaling and the HARQ buffer flushing signal of the invention are conveyed in the control message. Each frame in a multiple access communication system such as OFDMA includes a signaling or control portion where the system informs users (via the DL) or users inform the system (via the UL) on various parameters including HARQ related information. Note that the actual method used to convey HARQ buffer flushing related messaging is not critical to the invention. The control message format shown herein is provided for illustration purposes only and may be conveyed in other types of message without departing from the scope of the invention.

A more detailed description of the conventional message fields can be found in the 3rd Generation Partnership Project (3GPP), Technical Specification Group Radio Access Network, PHY Layer aspects for evolved Universal Terrestrial Radio Access (UTRA) (TR 25.814 V7.1. 0), incorporated herein by reference.

The downlink control signaling comprises, for example, scheduling information for downlink data transmission, scheduling grants for uplink transmission and ACK/NAK indications in response to uplink transmission. Downlink scheduling information is used to inform the UE as to how to process downlink data. Typical information signaled to a UE scheduled to receive user data is shown in FIG. 14.

With reference to FIG. 14, the control message comprises an indication 132 of the u-ID or group of u-IDs assigned resources in that frame. Resource related information may include (1) an indication or reference to the particular resource assigned 134 (e.g., time, frequency, space, etc. or any combination thereof) and (2) the time duration 136 the assignment is valid. The data transferring format information may comprise MIMO mode related data 138 to indicate that the content depends on particular MIMO schemes indicated as well as the modulation scheme 140 utilized for the assigned resource (e.g., QPSK, 16QAM, 64QAM), payload size 142, conventional HARQ information 144 to indicate the hybrid ARQ process the current transmission is addressing and HARQ buffer flushing messaging 146 including related indications and parameters.

### Buffer Flushing Criteria

Several type, length, value (TLV) based messages are defined to support the HARQ mechanism of the invention. A single byte TLV adapted to indicate the type of basis for the buffer flushing criteria is defined whereby a separate bit is assigned to indicate each of the following:

1. buffer flushing based on link quality: parameters include Channel Quality Indicators (CQI), Carrier to Interferences and Noise Ratio (CINR) mean, CINR standard deviation, Received Signal Strength (RSS) mean, RSS standard deviation, timing adjustment, offset frequency adjustment, BER, PER, BLER, optimal transmission profile, and estimated number of error bits whereby an identification of too many errors or a sufficiently high probability for errors exists in the burst will trigger a flush event, and the like, and any combination thereof.

2. buffer flushing based on data sent on other subchannels: data within the burst was already sent through other HARQ sub-channels.

3. QoS level buffer flushing based on higher priority data pending: higher priority (low jitter, low latency) data is pending transmission and requires release of the HARQ buffer associated with a CID and/or ACID.

4. buffer flushing based on stale data: data within the burst is no longer needed due to a breach of link parameters (e.g., jitter, latency, etc.).

5. buffer flushing based on handover: flushing due to transition to a new cell.

6. buffer flushing based on HARQ subchannel loss of synchronization: flushing due to the loss of synchronization of the stop and go HARQ mechanism.

7. buffer flushing based on buffer occupancy, wherein the buffer is flushed if it becomes full or fills to a certain level (e.g., 80% full).

A TLV to support link quality based flushing may comprise fields for indicating: (1) carrier to interference-plus-noise ratio (CINR) threshold; (2) duration threshold; (3) RSSI threshold; (4) retransmission limit; (5) SNR threshold; and (6) retransmission level limit; (7) MIMO/STC/AAS capability threshold. Any or all of these measurement thresholds may be used to trigger a buffer flushing operation.

A TLV to support flushing based on data sent on other subchannels may comprise fields for indicating: (1) data sent TLV; (2) basic connection ID (CID); and (3) a flushed subchannel indicator, i.e. bits 0-15 indicating a flush command on ACIDs 0-15, respectively.

A TLV to support flushing based on higher priority data pending may comprise fields for indicating: higher priority data TLV; (2) basic CID; and (3) a flushed subchannel indicator, i.e. bits 0-15 indicating a flush command on ACIDs 0-15, respectively.

Note that the HARQ buffer flushing configuration (or reconfiguration) can be associated with (1) MAC flows (e.g., known as CIDs in WiMAX terminology), (2) HARQ flows (e.g., known as ACID in WiMAX) or (3) a single HARQ buffer or cluster of buffers that may or may not share a common storage resource. The send (or receive) buffer on each end of the link comprises a HARQ process buffer. The send buffer is adapted to store and retain information units for possible retransmission to the wireless network in the event the wireless network does not successfully receive the information units. The send buffer may also store and retain information units that have not yet been sent. After information units are placed in the send buffer, they are immediately transmitted. Thus, the information units become ‘sent’ information units almost as soon as they are placed in the send buffer. In the case the buffers utilize common storage, a management entity functions to manage the memory (e.g., allocating space for storage, deleting flushed buffers, etc.) and allocate and associate storage locations with the transmitter's scheduling operation.

### Buffer Flushing Methods

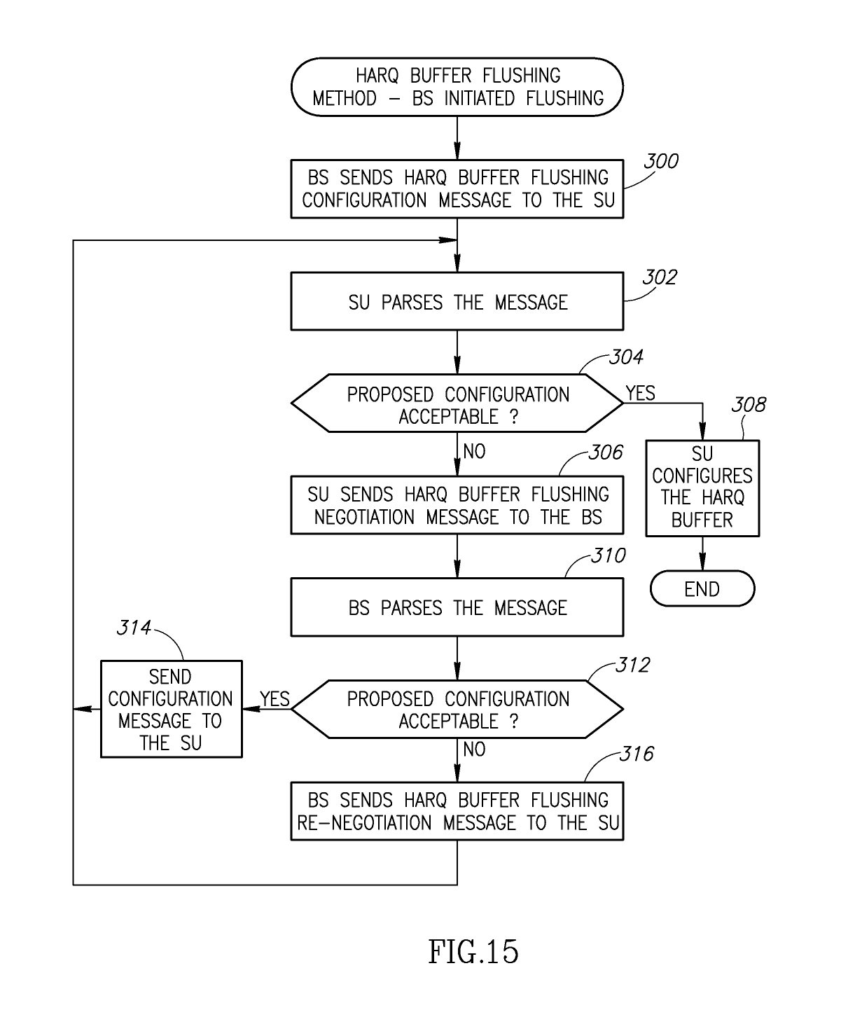

A flow diagram illustrating the BS initiated HARQ buffer flushing method of the present invention is shown in FIG. 15. With reference to FIGS. 11 and 13, the radio access network 282 first makes a decision to configure or reconfigure the SU 286 with a set of HARQ buffer flushing parameters that will trigger a buffer flushing operation if certain criteria are met (i.e. occurrence of a particular event). One of the base stations the SU is communicatively coupled to generates a HARQ buffer flushing configuration message and sends it to the SU (step 300). The SU receives the message and parses it (step 302). Once the configuration message is parsed, the SU makes a determination whether, based on prior configurations, the currently received configuration set is acceptable (i.e. suitable) (step 304). If the configuration set is acceptable to the SU, the SU then uses the configuration message data to configure the HARQ buffer flushing operation (step 308).

On the other hand, however, if the configuration set is not acceptable to the SU (step 304), then the SU sends a HARQ buffer flushing negotiation massage to the wireless network device (i.e. the BS) (step 306). The BS then parses the message (step 310) and determines, based on prior configuration, whether the configuration set is acceptable (i.e. suitable) (step 312). If the configuration is acceptable, a confirmation message indicating this is sent to the SU (step 314). If the configuration is not acceptable (step 312), the BS sends a HARQ buffer flushing re-negotiation message to the SU (step 316) and the method continues with the SU parsing the re-negotiation message (step 302). This process of negotiation may be repeated a number of times before the SU and BS agree on an acceptable configuration set. Once agreed on, the HARQ buffer flushing control logic in the SU is configured with the new configuration set.

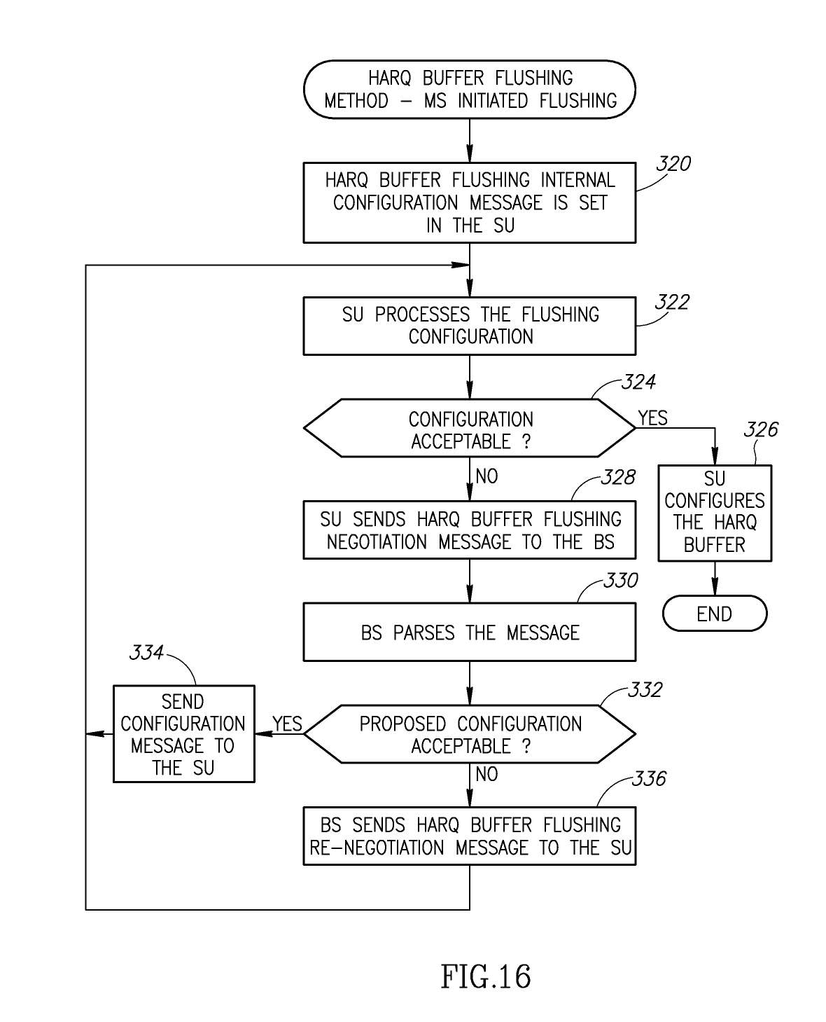

A flow diagram illustrating the MS initiated HARQ buffer flushing method of the present invention is shown in FIG. 16. With reference to FIGS. 11 and 13, in this method, the SU itself, via one or more internal processes, decides to configure or reconfigure its HARQ buffer with a set of HARQ buffer flushing parameters that will trigger a buffer flushing operation if certain criteria are met (i.e. occurrence of a particular event) and to flush the send buffer prior to the configuration. In this case, the internal configuration is set in the SU autonomously via internal interface 299, without any initiation from the BS (step 320). The SU receives the internal flushing configuration message and processes it (step 322). Once the configuration message is parsed, the SU makes a determination whether, based on prior configurations, the configuration set is acceptable (i.e. suitable) or whether there is a need to send a flushing negotiation message to the BS (step 324). If the configuration set is acceptable to the SU, the SU then uses the configuration message data to configure the HARQ buffer flushing operation (step 336).

On the other hand, however, if the configuration set is not acceptable to the SU (step 324), there is a need for the US to send a HARQ buffer flushing negotiation massage to the wireless network device (i.e. the BS) (step 328). The BS then parses the message (step 330) and determines, based on prior configuration, whether the configuration set is acceptable (i.e. suitable) (step 332). If the configuration is acceptable, a confirmation message indicating this is sent to the SU (step 334). If the configuration is not acceptable (step 336), the BS sends a HARQ buffer flushing re-negotiation message to the SU (step 316) and the method continues with the SU parsing the re-negotiation message (step 322). This process of negotiation may be repeated a number of times before the SU and BS agree on an acceptable configuration set. Once agreed on, the HARQ buffer flushing control logic in the SU is configured with the new configuration set.

The configuration set comprises one or more criteria as listed in the Buffer Flushing Criteria section supra. The various valid ranges and thresholds associated with the criteria used are predefined and/or configured in the device. Periodically or at some other appropriate time(s), the ranges and thresholds are compared against current values to determine whether a buffer flushing event should be triggered.

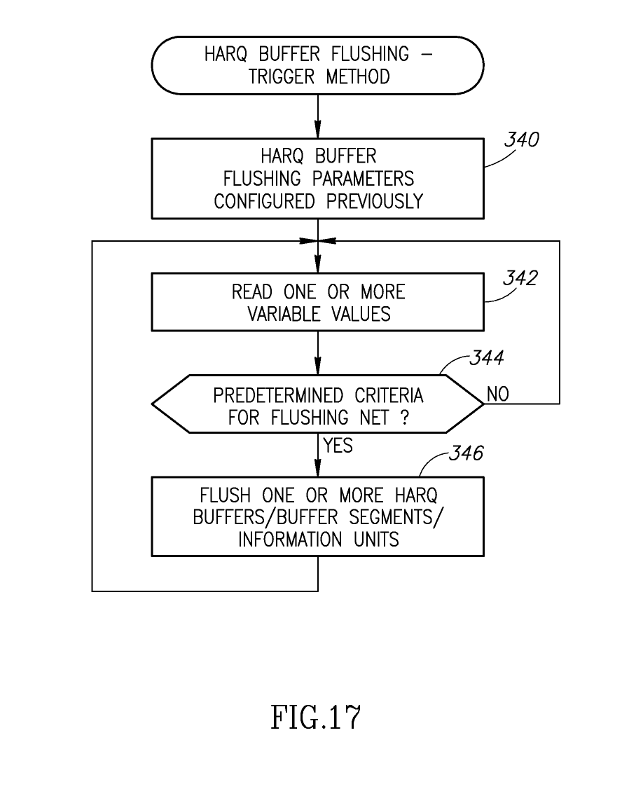

A flow diagram illustrating the receiver based control channel signaling method of the present invention is shown in FIG. 17. Once the HARQ buffer flushing parameters have been configured (step 340), a buffer flushing operation can be triggered. The SU (or other network element) reads one or more variable values (step 342). Note that the variables values may comprise one or more internal or external measurements performed by the SU or other element. The readings are then compared to predetermined criteria configured previously (step 344). If the criteria are met, then one or more HARQ buffers, buffer segments, information units, etc. are either fully or partially flushed (step 346). The method then continues to obtain new variable values such as on a period or other basis.

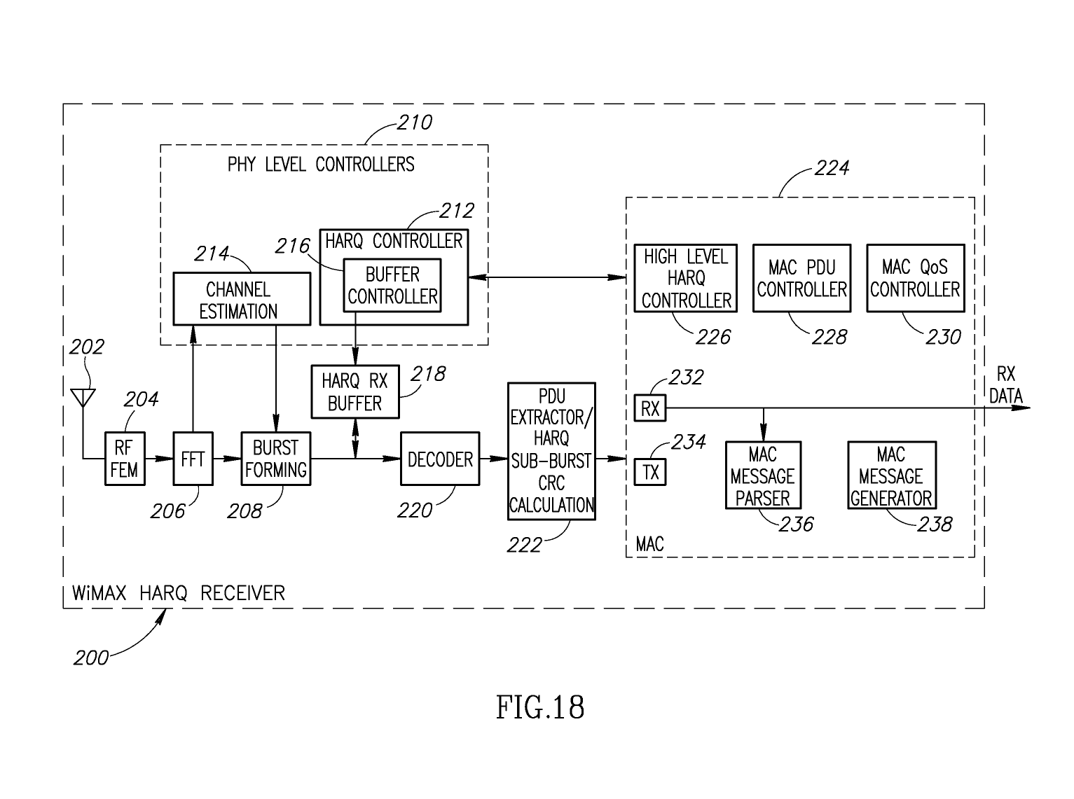

As an aid in illustrating the invention, example transmitter and receiver circuits with HARQ implemented and adapted to the WiMAX wireless standard are provided. A diagram illustrating an example WiMAX receiver incorporating the HARQ buffer flushing mechanism of the present invention is shown in FIG. 18. The WiMAX HARQ receiver, generally referenced 200, comprises an antenna 202, RF front end module (FEM) 204, forward FFT block 206, burst forming block 208, HARQ receive buffer 218, decoder 220, PDU extractor/HARQ sub-burst CRC calculation block 222, PHY level controllers 210 and MAC 224 which provides the Rx data output. Note that WiMAX receivers are well-known in the art. A buffer flushing block is added to the WiMAX receiver which is adapted to implement the buffer flushing mechanism of the present invention as described in detail supra. Note that the HARQ sub-burst CRC calculation may be performed before, after or unified with the PDU extractor depending on the particular implementation

The PHY level controllers 210 comprise a channel estimation block 214 and HARQ controller 212 comprising a buffer controller 216. The MAC 224 comprises an RX block 232, TX block 234, MAC message parser 236, MAC message generator 238, high level HARQ controller 226, MAC PDU controller 228 and MAC QoS controller 230. Note that in the receive direction, the TX block 234 and MAC message generator 238 are used for feedback purposes.

In accordance with the invention, the high level HARQ controller 226, buffer controller 216 in the HARQ controller 212 and HARQ RX buffer 218 combine to implement the buffer flushing mechanism of the invention. Via the MAC, the receiver negotiates with the network element on the other end of the link to determine the configuration of the HARQ. Once configured, the HARQ RX buffer 218 is flushed whenever the particular flushing criteria is met.

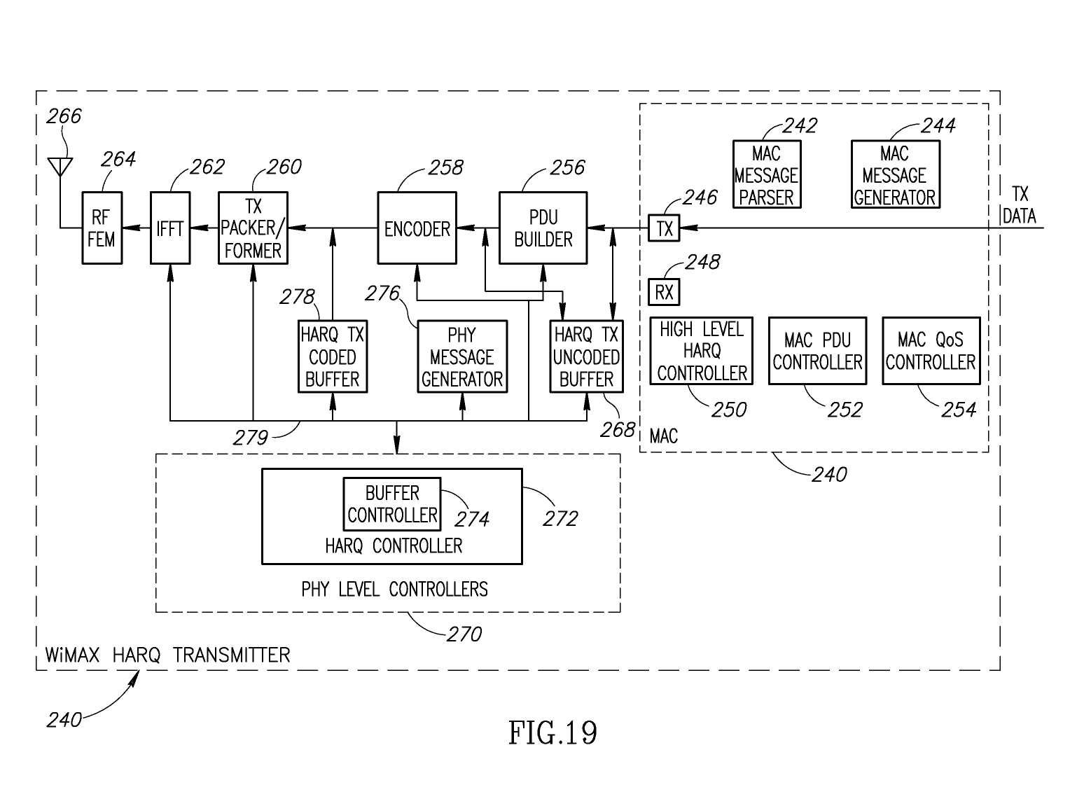

A diagram illustrating an example WiMAX transmitter incorporating the HARQ buffer flushing mechanism of the present invention is shown in FIG. 19. The WiMAX HARQ transmitter, generally referenced 240, MAC 240 which receives the TX data to be transmitted, PHY level controllers 270, PDU builder 256, HARQ TX uncoded buffer 268, encoder 258, PHY message generator 276, HARQ TX coded buffer 278, TX packet/former 260, inverse FFT (IFFT) 262, RF front end module 264 and antenna 266. Note that WiMAX transmitters are well-known in the art. A buffer flushing block is added to the WiMAX transmitter which is adapted to implement the buffer flushing mechanism of the present invention as described in detail supra.

The PHY level controllers 270 comprise a HARQ controller 272 comprising a buffer controller 274. The MAC 240 comprises an RX block 248, TX block 234, MAC message parser 242, MAC message generator 244, high level HARQ controller 250, MAC PDU controller 252 and MAC QoS controller 254. Note that in the transmit direction, transmission is based on feedback received and processed in the MAC message parser block 242. Note further that there are three possible HARQ buffer configurations: (1) HARQ uncoded buffer 268 only (i.e. HARQ is performed using a TX buffer located before the encoder 258); (2) HARQ coded buffer 278 only (i.e. HARQ is performed using a TX buffer located after the encoder 258); and (3) the combination of HARQ uncoded buffer 268 and HARQ coded buffer 278.

In accordance with the invention, the high level HARQ controller 250, buffer controller 274 in the HARQ controller 272 and HARQ TX buffers (any combination of coded and/or uncoded buffer) combine to implement the buffer flushing mechanism of the invention. Via the MAC, the transmitter negotiates with the network element on the other end of the link to determine the configuration of the HARQ. Once configured, the HARQ TX buffer (coded or uncoded) is flushed whenever the particular flushing criteria is met.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of buffer flushing for use over a communications link, said method comprising the step of:
configuring a communication device coupled to said link with buffer flushing criteria that if met, triggers a buffer flushing operation in said communication device.

2. The method according to claim 1, wherein said buffer flushing operation is performed on one or more information units within one or more buffers.

3. The method according to claim 1, wherein said buffer flushing operation is performed on one or more information units within one or more receive buffers.

4. A method of buffer flushing signaling for use in subscriber unit (SU) device within a radio access network (RAN), said method comprising the steps of:
receiving a buffer flushing message from said RAN comprising buffer flushing criteria; and
configuring said SU device in accordance with said buffer flushing criteria.

5. The method according to claim 4, further comprising the step of triggering a flushing operation of one or more communication buffers in said SU device when said criteria is met.

6. The method according to claim 4, wherein said buffer flushing message comprises an indication to said SU device that a reconfiguration is to be performed.

7. The method according to claim 4, further comprising the step of negotiating said buffer flushing criteria between said SU device and said RAN.

8. The method according to claim 4, further comprising the step of sending confirmation of said buffer flushing criteria to said RAN if said buffer flushing criteria is acceptable to said SU device.

9. The method according to claim 4, wherein said method is adapted to be performed in an application specific integrated circuit (ASIC).

10. A method of buffer flushing signaling for use in a radio access network (RAN) element, said method comprising the step of:
transmitting a buffer flushing configuration message comprising buffer flushing criteria to a subscriber unit (SU) device, wherein a buffer flushing operation is triggered in said SU device if said criteria is met.

11. The method according to claim 10, wherein said step of transmitting said buffer flushing configuration message is performed in response to determining that said SU device is to flush one or more information units from one or more of its communication buffers.

12. The method according to claim 10, further comprising the step of receiving confirmation of said buffer flushing criteria from said SU device if said buffer flushing criteria is acceptable to said SU device.

13. The method according to claim 10, further comprising the step of negotiating said buffer flushing criteria between said SU device and said RAN element.

14. The method according to claim 10, further comprising the step of receiving a re-negotiation message comprising proposed modified flushing criteria for consideration by said RAN element if said buffer flushing criteria is not acceptable to said SU device.

15. The method according to claim 10, wherein said buffer flushing configuration message comprises an indication to said SU device that a reconfiguration of said SU device is to be performed.

16. The method according to claim 10, wherein said buffer flushing operation is performed on one or more information units within one or more communication buffers in said SU device.

17. The method according to claim 10, wherein said method is adapted to be performed in an application specific integrated circuit (ASIC).

18. An apparatus for buffer flushing signaling in a radio access network (RAN), comprising:
a communications buffer;
a buffer controller coupled to said buffer and operative to execute a hybrid automatic repeat request (HARQ) protocol;
receiving means for receiving a buffer flushing configuration message; and
configuration means for configuring said buffer controller in accordance with said buffer flushing configuration message.

19. The apparatus according to claim 18, wherein said configuration means comprises means for triggering a buffer flushing operation if buffer flushing criteria received in said buffer flushing configuration message is met.

20. The apparatus according to claim 19, further comprising means for negotiating said buffer flushing criteria between two devices within said RAN.

21. The apparatus according to claim 19, further comprising means for sending confirmation of said buffer flushing criteria if said buffer flushing criteria is acceptable.

22. The apparatus according to claim 19, wherein said buffer flushing operation is performed on one or more information units within one or more communication buffers.

23. The apparatus according to claim 18, wherein said buffer flushing configuration message comprises an indication that a reconfiguration is to be performed.

24. A subscriber unit (SU) device coupled to a radio access network (RAN), comprising:
a transmitter;
a receiver;
a baseband processor coupled to said transmitter and said receiver;
a hybrid automatic repeat request (HARQ) module coupled to said baseband processor,
said HARQ module comprising:
a communications buffer;
a buffer controller coupled to said buffer and operative to execute a hybrid automatic repeat request (HARQ) protocol;
receiving means for receiving buffer flushing criteria from said RAN; and
configuration means for configuring said buffer controller in accordance with said buffer flushing criteria such that said buffer controller triggers a flushing operation of said communications buffer when said criteria is met.

25. The SU device according to claim 24, further comprising means for receiving an indication that a reconfiguration is to be performed.
